(19) United States
(12) Patent Application Publication
(10) Pub. No.: US 2015/0042933 A1
(43) Pub. Date: Feb. 12, 2015

(54) FLUORESCENT SUBSTRATE AND DISPLAY DEVICE PROVIDED WITH SAME

(71) Applicant: Sharp Kabushiki Kaisha, Osaka (JP)

(72) Inventors: Shun Ueki, Osaka (JP); Masahiro Tsujimoto, Osaka (JP); Kazuyoshi Sakuragi, Osaka (JP); Tsuyoshi Kamada, Osaka (JP); Shohei Katsuta, Osaka (JP); Daisuke Shinozaki, Osaka (JP)

(73) Assignee: Sharp Kabushiki Kaidsha, Osaka (JP)

(21) Appl. No.: 14/384,381

(22) PCT Filed: Mar. 5, 2013
(86) PCT No.: PCT/JP2013/055920

§ 371 Date: Sep. 10, 2014

(30) Foreign Application Priority Data
Mar. 16, 2012 (JP) 2012-060735

(51) Int. Cl. G02F 1/1335; G02B 5/02; G02B 5/20

(52) U.S. Cl. CPC G02F 1/133617; G02F 1/133621; G02B 5/201; G02B 5/0242
USPC 349/108; 359/891; 359/599

(57) ABSTRACT

Provided are a fluorescent substrate that prevents the occurrence of the phenomenon in which the display color becomes faint and a display device provided with the same. A fluorescent substrate 10 includes a substrate 11; pixels 12 provided on the substrate 11; and partitions 13 that partition the pixels 12, wherein each of the pixels 12 includes at least a red sub-pixel 12R that performs display of red light; a blue sub-pixel 12B that performs display of blue light; and a third color sub-pixel that performs display of third color light different from the two colors, and wherein a distance between the red sub-pixel 12R and the blue sub-pixel 12B is greater than a distance between other sub-pixels.

### TECHNICAL FIELD

The invention relates to a fluorescent substrate and a display device provided with the same.

### BACKGROUND ART

Recently, there has been an increasing need to change from a display device using a Braun tube which is commonly used in the related art to a thin-type flat panel display (FPD) display device. There are various kinds of FPDs. For example, a non-self-luminous liquid crystal display (LCD), a self-luminous plasma display panel (PDP), an inorganic electroluminescence (inorganic EL) display, an organic electroluminescence (organic EL) display, and the like are known.

There is known an organic EL display including an organic EL element that has an organic light emitting layer emitting blue to blue green emission light, a green pixel made from a phosphor layer that absorbs the blue to blue green emission light from the organic EL element as excitation light and emits green light, a red pixel made from a phosphor layer that absorbs the blue to blue green emission light as excitation light and emits red light, and a blue pixel made from a phosphor layer that absorbs the blue to blue green emission light as excitation light and emits blue light, or a light scattering layer that scatters the blue to blue green emission light and capable of emitting full color light.

In a display device using a fluorescent substrate including the phosphor layer as described above, light rays of pixels of different colors become easily mixed, and as a result, a phenomenon in which the display light becomes faint (color fading) may occur. In particular, marked color fading of red display occurs when the excitation light intended to be incident on the red sub-pixel becomes incident on the blue sub-pixel, and the blue emission light from the blue sub-pixel becomes mixed with the red emission light from the red sub-pixel.

It is considered that such color fading occurs because there is a large distance between a light amount modulation layer that is formed of a liquid crystal layer including a light polarizing plate and the fluorescent substrate. That is, it is thought that the excitation light that passes through the light amount modulation layer corresponding to the red sub-pixel is incident on an adjacent sub-pixel of a different color and is scattered (excites a phosphor) thus becoming a cause of the color fading.

As a display device that solves such a problem, there is known a display device in which the widths of opening portions of respective pixels are small and the excitation light that is intended to be incident on the red sub-pixel is prevented from becoming incident on adjacent sub-pixels of other colors using a microlens (for example, see PTL 1).

### CITATION LIST

### Patent Literature

PTL 1: Japanese Unexamined Patent Application Publication No. 2009-134275

### SUMMARY OF INVENTION

### Technical Problem

However, if the widths of the opening portions of the respective pixels are small, the light amounts emitted from respective sub-pixels become small and light emission efficiency of the display device decreases. Further, if the microlens is used, members configuring the display device increase, so that the cost becomes high.

The invention is suggested in view of the above circumstances, and an object of the invention is to provide a fluorescent substrate that has wide opening portions to have high efficiency, that has less configuring members in order to be capable of easily forming a display device, and that can suppress the influence of the color fading to a minimum, and a display device provided with the same.

### Solution to Problem

A fluorescent substrate according to the invention includes a substrate; pixels provided on the substrate; and partition that partition the pixels, wherein each of the pixel includes at least a red sub-pixel that performs display of red light; a blue sub-pixel that performs display of blue light; and a third color sub-pixel that performs display of third color light different from the two colors, and wherein a distance between the red sub-pixel and the blue sub-pixel is greater than a distance between other sub-pixels.

### Advantageous Effects of Invention

According to the invention, it is possible to provide a fluorescent substrate that prevents the occurrence of the phenomenon in which the display color becomes faint.

### BRIEF DESCRIPTION OF DRAWINGS

FIG. 1 is a schematic cross-sectional view illustrating a fluorescent substrate according to a first embodiment.

FIG. 2 is a schematic cross-sectional view illustrating a fluorescent substrate according to a second embodiment.

FIG. 3 is a schematic cross-sectional view illustrating a fluorescent substrate according to a third embodiment.

FIG. 4 is a schematic cross-sectional view illustrating a fluorescent substrate according to a fourth embodiment.

FIG. 5 is a schematic cross-sectional view illustrating a fluorescent substrate according to a fifth embodiment.

FIG. 6 is a schematic cross-sectional view illustrating a fluorescent substrate according to a sixth embodiment.

FIG. 7 is a schematic diagram illustrating a fluorescent substrate according to a seventh embodiment, and FIG. 7(a) is a plan view and FIG. 7(b) is a cross-sectional view taken along the line A-A of FIG. 7(a).

FIG. 8 is a schematic diagram illustrating a fluorescent substrate according to an eighth embodiment, and FIG. 8(a) is a plan view, and FIG. 8(b) is a cross-sectional view taken along the line B-B of FIG. 8(a).

FIG. 9 illustrates a chromaticity coordinate diagram illustrating a color reproduction range of a display device having spectrums of three primary colors, and is a diagram illustrating a method of determining main wavelengths of sub-pixels of respective colors.

FIG. 10 is a schematic cross-sectional view illustrating a display device according to an embodiment.

FIG. 11 is a schematic cross-sectional view illustrating an organic EL element substrate configuring a light source according to an embodiment.

FIG. 12 is a schematic cross-sectional view illustrating an LED substrate configuring the light source according to an embodiment.

FIG. 13 is a schematic cross-sectional view illustrating an inorganic EL element substrate configuring the light source according to an embodiment.

FIG. 14 is a diagram illustrating an external appearance of a cellular phone which is an application example of the display device.

FIG. 15 is a diagram illustrating an external appearance of a thin-type television which is an application example of the display device.

FIG. 16 is a diagram illustrating an external appearance of a portable game machine which is an application example of the display device.

FIG. 17 is a diagram illustrating an external appearance of a notebook computer which is an application example of the display device.

FIG. 18 is a diagram illustrating an external appearance of a tablet terminal which is an application example of the display device.

FIG. 19 is a graph illustrating spectrums of emission light of a display device according to Example 1.

FIG. 20 is a partially expanded diagram illustrating a chromaticity coordinate diagram indicating the color reproduction range of a display device having spectrums of three primary colors according to Example 1 and Comparative Example 1.

FIG. 21 is a partially expanded diagram illustrating a chromaticity coordinate diagram indicating the color reproduction range of a display device having spectrums of three primary colors according to Example 1 and Comparative Example 1.

FIG. 22 is a partially expanded diagram illustrating a chromaticity coordinate diagram indicating the color reproduction range of a display device having spectrums of three primary colors according to Example 2 and Comparative Example 2.

FIG. 23 is a partially expanded diagram illustrating a chromaticity coordinate diagram indicating the color reproduction range of a display device having spectrums of three primary colors according to Example 3.

### DESCRIPTION OF EMBODIMENTS

Embodiments of a fluorescent substrate according to the invention and a display device including the same are described.

In addition, the present embodiment is to specifically describe the gist of the invention in order to easily understand the gist of the invention, and if it is not especially defined, the present embodiment is not intended to limit the invention.

### Fluorescent Substrate

### (1) First Embodiment

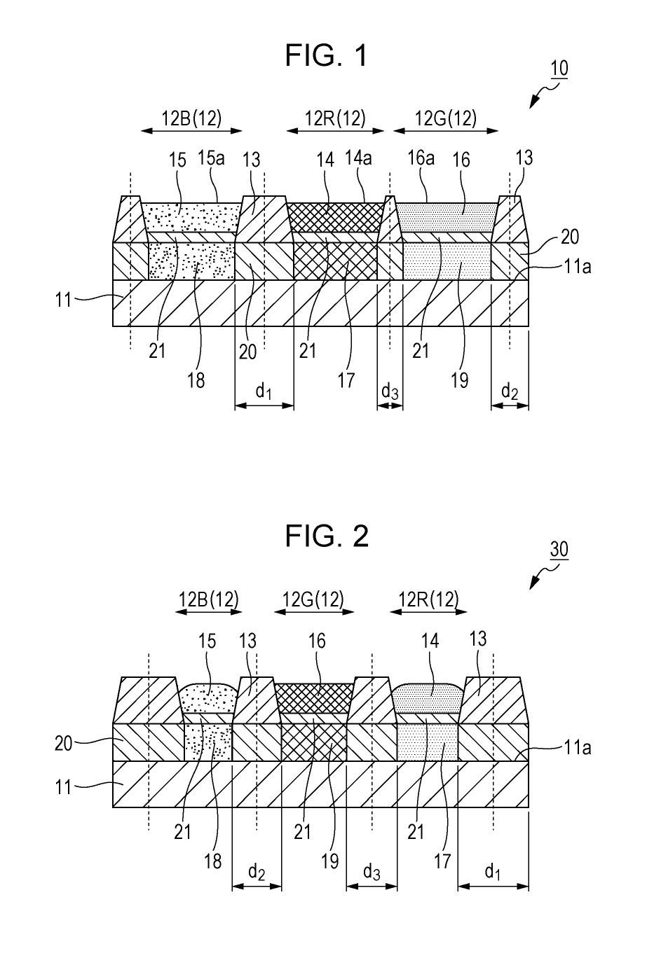

FIG. 1 is a schematic cross-sectional view illustrating a fluorescent substrate according to a first embodiment.

A fluorescent substrate 10 according to the embodiment is mainly formed of a substrate 11, pixels 12 that are provided on one surface 11a of the substrate 11, and partitions 13 that partition the pixels 12.

Each of the pixels 12 is formed of a red sub-pixel 12R that performs display by red light, a blue sub-pixel 12B that performs display by blue light, and a green sub-pixel 12G that performs display by green light. Further, the red sub-pixel 12R, the blue sub-pixel 12B, and the green sub-pixel 12G are arranged in parallel in one of the pixels 12.

Further, the red sub-pixel 12R is provided with a red phosphor layer 14 that emits red light (fluorescent light) by excitation light incident from a excitation light source (not illustrated), the blue sub-pixel 12B is provided with a blue phosphor layer 15 that causes excitation light incident from the excitation light source (not illustrated) to be dispersed, and the green sub-pixel 12G is provided with a green phosphor layer 16 that emits green light (fluorescent light) by the excitation light incident from the excitation light source (not illustrated).

A red color filter 17 is provided in the red sub-pixel 12R between the substrate 11 and the red phosphor layer 14, the blue phosphor layer 15, or the green phosphor layer 16. Further, a blue color filter 18 is provided in the blue sub-pixel 12B between the substrate 11 and the red phosphor layer 14, the blue phosphor layer 15, or the green phosphor layer 16. Additionally, a green color filter 19 is provided in the green sub-pixel 12G between the substrate 11 and the red phosphor layer 14, the blue phosphor layer 15, or the green phosphor layer 16.

Further, a black matrix 20 are provided between the substrate 11 and the partitions 13 in the thickness direction of the fluorescent substrate 10, and between the red color filter 17 and the blue color filter 18, between the blue color filter 18 and the green color filter 19, and between the green color filter 19 and the red color filter 17 in the thickness direction of the fluorescent substrate 10.

Additionally, a low refractive index layer 21 that has a lower refractive index than a refractive index of the substrate 11, or than the refractive indexes of the red phosphor layer 14, the blue phosphor layer 15, and the green phosphor layer 16 is provided between the red phosphor layer 14, the blue phosphor layer 15, and the green phosphor layer 16 and color filters (the red color filter 17, the blue color filter 18, and the green color filter 19).

Further, if a distance between the red sub-pixel 12R and the blue sub-pixel 12B, that is, a distance between the red phosphor layer 14 and the blue phosphor layer 15 is set to be d₁, a distance between the blue sub-pixel 12B and the green sub-pixel 12G, that is, a distance between the blue phosphor layer 15 and the green phosphor layer 16 is set to be d₂, a distance between the green sub-pixel 12G and the red sub-pixel 12R, that is a distance between the green phosphor layer 16 and the red phosphor layer 14 is set to be d₃, the distances d₁, d₂ and d₃ satisfy a relationship of d₁>d₂>d₃.

In addition, the distance d₁ corresponds to a width of the black matrix 20 between the red sub-pixel 12R and the blue sub-pixel 12B. Further, the distance d₂ corresponds to a width of the black matrix 20 between the blue sub-pixel 12B and the green sub-pixel 12G. Further, the distance d₃ corresponds to a width of the black matrix 20 between the green sub-pixel 12G and the red sub-pixel 12R.

Hereinafter, constituent members and a forming method of the fluorescent substrate 10 are described in detail, but the constituent members and the forming method of the fluorescent substrate 10 are not limited thereto.

### (Substrate)

Since emission light needs to be extracted from the red phosphor layer 14, the blue phosphor layer 15, and the green phosphor layer 16, light emitting areas of the red phosphor layer 14, the blue phosphor layer 15, and the green phosphor layer 16 need light to pass therethrough, and examples of the substrate 11 include inorganic material substrates made of glass, quartz, or the like, or plastic substrates made of polyethyleneterephthalate, polycarbazole, polyimide, or the like. However, the present embodiment is not limited to these substrates.

Among these substrates, it is preferable to use a plastic substrate since it is possible to form a bent portion or a folded portion without stress. Additionally, from the view point of enhancing a gas barrier property, a substrate obtained by coating an inorganic material on the plastic substrate is more preferable.

### (Phosphor Layer)

The red phosphor layer 14, the blue phosphor layer 15, and the green phosphor layer 16 absorb excitation light from excitation light sources such as an organic ultraviolet EL element, an organic blue EL element, an ultraviolet LED, and a blue LED, and emit red, green, and blue light. However, when blue emission light having directivity is applied as the excitation light source, a light scattering layer that can scatter the excitation light having directivity and extract the light as isotropic emission light to the outside may be adopted without providing the blue phosphor layer 15.

Further, it is preferable to add phosphor layers that emit light as cyan light and yellow light to the pixels, if necessary. Here, respective color purities of the pixels that emit the light as cyan light and yellow light are positioned on the outside of a triangle obtained by connecting points of color purities of pixels that emit light in red, green, and blue in a chromaticity diagram, so that a color reproduction range can be more broadened than the color reproduction range of a display device using pixels that emit light in three primary colors of red, green, and blue.

The red phosphor layer 14, the blue phosphor layer 15, and the green phosphor layer 16 may be formed only of fluorescent materials described below, an addition agent or the like may be arbitrarily included, the materials may be dispersed in a high molecular material (binder resin) or an inorganic material.

As the fluorescent material, fluorescent materials according to the related art can be used. Such fluorescent materials are classified into organic-based fluorescent materials or inorganic-based fluorescent materials. Hereinafter, specific compounds of the organic-based fluorescent materials and the inorganic-based fluorescent materials are exemplified, but the fluorescent materials are not limited to these materials.

In organic-based fluorescent materials, examples of a blue fluorescent pigment include a stilbenzene-based pigment: 1,4-bis(2-methylstyryl)benzene or trans-4,4′-diphenylstilbenzene, and a coumarin-based pigment: 7-hydroxy-4-methylcoumarin.

Further, examples of a green fluorescent pigment include a coumarin-based pigment: 2,3,5,6-1H,4H-tetrahydro-8-trifluoromethylquinolizine(9,9a,1-gh)coumarin (coumarin 153), 3-(2′-benzothiazolyl)-7-diethylaminocoumarin (coumarin 6), and 3-(2′-benzoimidazolyl)-7-N,N-diethylaminocoumarin (coumarin 7), and a naphthalimido-based pigment: basic yellow 51, solvent yellow 11, and solvent yellow 116.

Further, examples of a red fluorescent pigment include a cyanine-based pigment: 4-dicyanomethylene-2-methyl-6-(p-dimethylaminostyryl)-4H-pyran, a pyridine-based pigment: 1-ethyl-2-[4-(p-dimethylaminophenyl)-1,3-butadienyl]-pyridinium-perchlorate, and a rhodamine-based pigment: rhodamine B, rhodamine 6G, rhodamine 3B, rhodamine 101, rhodamine 110, basic violet 11, and sulforhodamine 101.

In the inorganic-based fluorescent material, examples of a blue phosphor include Sr₂P₂O₇:Sn⁴⁺, Sr₄Al₁₄O₂₅:Eu²⁺, BaMgAl₁₀O₁₇:Eu²⁺, SrGa₂S₄:Ce³⁺, CaGa₂S₄:Ce³⁺, (Ba, Sr) (Mg, Mn)Al₁₀O₁₇:Eu²⁺, (Sr, Ca, Ba₂, Mg)₁₀(PO₄)₆Cl₂:Eu²⁺, BaAl₂SiO₈:Eu²⁺, Sr₂P₂O₇:Eu²⁺, Sr₅(PO₄)₃Cl:Eu²⁺, (Sr, Ca, Ba)₅(PO₄)₃Cl:Eu²⁺, BaMg₂Al₁₆O₂₇:Eu²⁺, (Ba, Ca)₅(PO₄)₃Cl:Eu²⁺, Ba₃MgSi₂O₈:Eu²⁺, and Sr₃MgSi₂O₈:Eu²⁺.

Further, examples of a green phosphor include (BaMg)Al₁₆O₂₇:Eu²⁺, Mn²⁺, Sr₄Al₁₄O₂₅:Eu²⁺, (SrBa)Al₁₂Si₂O₈:Eu²⁺, (BaMg)₂SiO₄:Eu²⁺, Y₂SiO₅:Ce³⁺, Tb³⁺, Sr₂P₂O₇—Sr₂B₂O₅:Eu²⁺, (BaCaMg)₅(PO₄)₃Cl:Eu²⁺, Sr₂Si₃O₈-2SrCl₂:Eu²⁺, Zr₂SiO₄, MgAl₁₁O₁₉: Ce³⁺, Tb³⁺, Ba₂SiO₄:Eu²⁺, Sr₂SiO₄:Eu²⁺, and (BaSr) SiO₄:Eu²⁺. Further, examples of a red phosphor include Y₂O₂S:Eu³⁺, YAlO₃:EuU³⁺, Ca₂Y₂(SiO₄)₆:Eu³⁺, LiY₉(SiO₄)₆O₂:Eu³⁺, YVO₄:Eu³⁺CaS:Eu, Gd₂O₃:Eu³⁺Gd₂O₂S:Eu³⁺Y(P,V)O₄:Eu, Mg₄GeO_{5.5}F:Mn⁴⁺, Mg₄GeO₆:Mn⁴⁺, K₅Eu_{2.5}(1361861841074_{—}0.aspx?ViewNo=WO4)_{6.25}, Na₅Eu_{2.5}(1361861841074_{—}1.aspx?ViewNo=WO4)_{6.25}, K₅Eu_{2.5}(MoO₄)_{6.25}, and Na₅Eu_{2.5}(MoO₄)_{6.25}.

Further, the inorganic-based fluorescent materials may be subjected to surface reformation processing, if necessary. Examples of the method thereof include chemical processing using a silane coupling agent or the like, physical processing performed by adding fine particles on the submicron order or the like, or a combination thereof.

Further, if stability problems such as deterioration by excitation light and deterioration by emission light are considered, it is preferable to use an inorganic-based fluorescent material as the fluorescent material. Additionally, when the inorganic-based fluorescent material is used, the average particle diameter (d₅₀) preferably ranges from 0.5 μm to 50 μm. If the average particle diameter of the inorganic-based fluorescent material is less than 0.5 μm, the light emission efficiency of the inorganic-based fluorescent material decreases. On the other hand, if the average particle diameter of the inorganic-based fluorescent material exceeds 50 μm, it becomes difficult to perform patterning at a high resolution.

Further, the red phosphor layer 14, the blue phosphor layer 15, and the green phosphor layer 16 can be formed by wet processes such as coating methods of a spin coating method, a dipping method, a doctor blade method, a discharge coating method, a spray coating method, or the like, and printing methods such as an ink-jet method, a letter press printing method, an intaglio printing method, a screen printing method, a microgravure coating method, or the like, by using a phosphor layer forming coating liquid obtained by dissolving and dispersing the fluorescent materials and resin materials in a solvent, dry processes according to the related art such as a resistance heating vapor deposition method, an electron beam (EB) deposition method, a molecular beam epitaxy (MBE) method, a sputtering method, and an organic vapor phase deposition (OVPD) method, by using the material, a laser transferring method, or the like.

Further, the red phosphor layer 14, the blue phosphor layer 15, and the green phosphor layer 16 can be patterned by a photolithographic method, by using a resin having photosensitivity (photosensitive resin), as the high molecular material (binder resin).

Here, as the photosensitive resin, one kind selected from the group consisting of photosensitive resins (photo-curing-type resist material) having a reactive vinyl group such as an acrylate resin, a methacrylate resin, a polyvinyl cinnamate resin, and a hard rubber-based resin, or a compound of two kinds thereof can be used.

Further, when the photosensitive resin is used, the red phosphor layer 14, the blue phosphor layer 15, and the green phosphor layer 16 can be formed by directly patterning the fluorescent material by wet processes such as an ink-jet method, a letter press printing method, an intaglio printing method, and a screen printing method, dry processes according to the related art such as a resistance heating vapor deposition method, an electron beam (EB) deposition method, a molecular beam epitaxy (MBE) method, a sputtering method, and an organic vapor phase deposition (OVPD) method using a shadow mask, or a laser transferring method.

The film thicknesses of the red phosphor layer 14, the blue phosphor layer 15, and the green phosphor layer 16 generally range approximately from 100 nm to 100 μm, but preferably from 1 μm to 100 μm. Further, it is preferable that the film thicknesses of the red phosphor layer 14, the blue phosphor layer 15, and the green phosphor layer 16 be equal to or greater than 1 μm, in order to increase the absorption of the excitation light from the excitation light source and to decrease the transmitted light of the excitation light to such an extent that is not negatively influenced the color purity.

If the film thicknesses of the red phosphor layer 14, the blue phosphor layer 15, and the green phosphor layer 16 are less than 100 nm, it may not be possible to sufficiently absorb the excitation light from the excitation light source. Therefore, problems of the decrease of the light emission efficiency and the deterioration of the color purity caused by the mixture of the transmitted light of the excitation light into the required color occur. Meanwhile, if the film thicknesses of the red phosphor layer 14, the blue phosphor layer 15, and the green phosphor layer 16 exceed 100 μm, the excitation light from the excitation light source is sufficiently absorbed already. Therefore, the larger film thicknesses do not lead to the increase of the light emission efficiency and merely increase the consumption of materials, thereby leading to the increase of the material cost.

Meanwhile, instead of the blue phosphor layer 15, when the light scattering layer is applied, the light scattering particles may be formed of the organic materials, or may be formed of the inorganic materials, but it is preferable to be formed of the inorganic materials. Accordingly, it is possible to isotropically and effectively diffuse or scatter the excitation light having directivity from the outside (for example, the excitation light source). Further, it is possible to form the light scattering layer which is stable against light or heat, by using the inorganic materials.

Further, as the light scattering particles, it is preferable to use highly transparent particles. Further, as the light scattering particles, it is preferable to use particles in which fine particles of a higher refractive index than a base material are dispersed in the base material of the low refractive index. Further, in order that the blue light is effectively scattered by the light scattering layer, it is required that the particle diameters of the light scattering particles are in the Mie scattering area. Therefore, it is preferable that the particle diameters of the light scattering particles range approximately from 100 nm to 500 nm.

In the light scattering particles, when the inorganic material is used, examples of the inorganic materials include particles (fine particles) including, as a main component, at least one kind of metal oxide selected from the group consisting of silicon, titanium, zirconium, aluminum, iridium, zinc, tin, and antimony.

Further, in the light scattering particles, when the particles (inorganic fine particles) formed from the inorganic material are used, examples of the inorganic fine particle include silica beads (refractive index: 1.44), alumina beads (refractive index: 1.63), titanium oxide beads (anatase-type refractive index: 2.50, rutile-type refractive index: 2.70), zirconium oxide beads (refractive index: 2.05), and zinc oxide beads (refractive index: 2.00).

As the light scattering particles, when the particles (organic fine particles) formed of the organic materials are used, examples of the organic fine particles include polymethylmethacrylate beads (refractive index: 1.49), acrylic beads (refractive index: 1.50), acrylic-styrene copolymer beads (refractive index: 1.54), melamine beads (refractive index: 1.57), high refractive index melamine beads (refractive index: 1.65), polycarbonate beads (refractive index: 1.57), styrene beads (refractive index: 1.60), cross-linked polystyrene beads (refractive index: 1.61), polyvinyl chloride beads (refractive index: 1.60), benzoguanamine-melamine formaldehyde beads (refractive index: 1.68), and silicone beads (refractive index: 1.50).

As the resin materials which are used by being mixed with the light scattering particles, it is preferable to use light transmitting resins. Examples of the resin materials include a melamine resin (refractive index: 1.57), nylon (refractive index: 1.53), polystyrene (refractive index: 1.60), melamine beads (refractive index: 1.57), polycarbonate (refractive index: 1.57), polyvinylchloride (refractive index: 1.60), polyvinylidenechloride (refractive index: 1.61), polyvinylacetate (refractive index: 1.46), polyethylene (refractive index: 1.53), polymethylmethacrylate (refractive index: 1.49), polyMBS (refractive index: 1.54), medium density polyethylene (refractive index: 1.53), high density polyethylene (refractive index: 1.54), tetrafluoroethylene (refractive index: 1.35), polychlorotrifluoroethylene (refractive index: 1.42), and polytetrafluoroethylene (refractive index: 1.35).

### (Partition)

The partition 13 has a tapered shape in which a width becomes narrower gradually as it is separated from the substrate 11 side.

Further, examples of the surface shapes of the partitions 13 include various shapes that enclose circumferences of the red phosphor layer 14, the blue phosphor layer 15, and the green phosphor layer 16, such as a matrix shape or a stripe shape.

The partitions 13 can be formed by patterning the resin materials such as a photosensitive polyimide resin, an acrylic resin, a methacryl-based resin, a novolak-based resin, or an epoxy resin by a method such as a photolithographic method.

In addition, the cross-sectional shape of the partition 13 is not limited to the tapered shape (forward tapered shape) in which a width becomes narrower gradually as it is separated from the substrate 11 side, but may be a tapered shape (reverse tapered shape) in which a width becomes wider gradually as it is separated from the substrate 11 side. Such a reverse tapered shape can be formed by using negative resist in which a light exposed portion is separated by development.

The partition 13 may have light reflectivity or a light scattering property in order to reflect or scatter fluorescent light generated in the red phosphor layer 14, the blue phosphor layer 15, and the green phosphor layer 16. Accordingly, it is possible to reflect fluorescent components laterally escaping from the red phosphor layer 14, the blue phosphor layer 15, and the green phosphor layer 16 to the red phosphor layer 14, the blue phosphor layer 15, and the green phosphor layer 16.

If the partition 13 has light reflectivity, the surface of the partition 13 may be covered with reflecting materials.

Examples of such reflecting materials include reflective metal such as aluminum, silver, gold, an aluminum-lithium alloy, an aluminum-neodymium alloy, and an aluminum-silicon alloy.

If the partition 13 has a light scattering property, the partition 13 may be formed of the material obtained by dispersing light scattering particles used in the light scattering layer in the resin material.

### (Color Filter)

Color filters according to the related art are used as the red color filter 17, the blue color filter 18, and the green color filter 19. Here, since the excitation light that is not absorbed in the red phosphor layer 14, the blue phosphor layer 15, and the green phosphor layer 16, and penetrates the phosphor layer can be prevented from being leaked to the outside by providing the color filters, it is possible to prevent the decrease of the color purity of the emission light caused by the color mixture of the emission light from the phosphor layer and the excitation light. Additionally, the color purities of the red sub-pixel 12R, the blue sub-pixel 12B, and the green sub-pixel 12G can be enhanced, and thus it is possible to expand the color reproduction range by the fluorescent substrate 10.

Further, since the red color filter 17 provided in the red sub-pixel 12R, the blue color filter 18 provided in the blue sub-pixel 12B, and the green color filter 19 provided in the green sub-pixel 12G absorb excitation light that excites respective fluorescent materials, it is possible to reduce or prevent the emission light of the red phosphor layer 14, the blue phosphor layer 15, and the green phosphor layer 16 from the external light, and it is possible to reduce or prevent the decrease of the contrast of the display by the fluorescent substrate 10. Meanwhile, since the excitation light that is not absorbed in the phosphor layer (the red phosphor layer 14, the blue phosphor layer 15, and the green phosphor layer 16) and penetrates the phosphor layer (the red phosphor layer 14, the blue phosphor layer 15, and the green phosphor layer 16) can be prevented from being leaked to the outside by the red color filter 17, the blue color filter 18, and the green color filter 19, it is possible to prevent the decrease of the color purity of the emission light caused by the color mixture of the emission light from the phosphor layer (the red phosphor layer 14, the blue phosphor layer 15, and the green phosphor layer 16) and the excitation light.

### (Low Refractive Index Layer)

The low refractive index layer 21 has a refractive index lower than the refractive index of the substrate 11, or the refractive indexes of the red phosphor layer 14, the blue phosphor layer 15, and the green phosphor layer 16.

Accordingly, it is possible to reduce the loss of the emission light generated by guiding the emission light (fluorescent light) from the red phosphor layer 14, the blue phosphor layer 15, and the green phosphor layer 16 through the substrate 11 that becomes the light emitting side, and guiding the emission light to the side surface of the substrate 11. That is, the difference between the refractive indexes of the low refractive index layer 21 and the substrate 11 is used to cause the light having an angle higher than the threshold angle that is not ejected from the substrate 11 to the air layer (outside) to be reflected by using the difference between the refractive indexes of the red phosphor layer 14, the blue phosphor layer 15, and the green phosphor layer 16, and the refractive index of the low refractive layer 21, and to cause the light to be reflected on the reflecting member (a reflecting layer that transmits the excitation light generated between the red phosphor layer 14, the blue phosphor layer 15, and the green phosphor layer 16, and the light source, and reflecting the emission light from the red phosphor layer 14, the blue phosphor layer 15, and the green phosphor layer 16 (a dielectric multilayered film, a band pass filter, or an ultrathin metal film), and a translucent electrode or a reflecting electrode provided in an inorganic EL portion or an organic EL portion) formed on the opposite side of the substrate 11 with interposing of the red phosphor layer 14, the blue phosphor layer 15, and the green phosphor layer 16, and the reflected light is emitted in the direction of the substrate 11, again, so that the loss of the emission light guided through the substrate 11 can be reduced. Therefore, it is possible to reduce the power consumption of the display device to which the fluorescent substrate 10 is applied, and to increase the brightness.

The materials that can be used in the low refractive index layer 21 is not especially limited, and the materials may be formed with the films of, for example, the fluorine-based resin (Poly(1,1,1,3,3,3-hexafluoroisopropyl acrylate):n=1.375, Poly(2,2,3,3,4,4,4-heptafluorobutyl methacrylate):n=1.383, Poly(2,2,3,3,3-pentafluoroproyl methacrylate):n=1.395, Poly(2,2,2-trifluoroethyl methacrylate):n=1.418, mesoporous silica (n=1.2), or aerogel (n=1.05), may be formed with air such as dry air or nitrogen introduced in a space between the red color filter 16, the green color filter 17, and the blue color filter 18, and the red phosphor layer 14, the blue phosphor layer 15, and the green phosphor layer 16, and may be formed in a state in which the pressure in the space is reduced.

### (Sealing Film)

Further, a sealing film is provided so as to cover surfaces (hereinafter, referred to as “one surfaces”) 14a, 15a, and 16a on the opposite side to the substrate 11 on the red phosphor layer 14, the blue phosphor layer 15, and the green phosphor layer 16.

The sealing film is formed by coating the resin on the one surfaces 14a, 15a, and 16a of the red phosphor layer 14, the blue phosphor layer 15, and the green phosphor layer 16 by using a spin coat method, an ODF, or a lamirate method. Otherwise, after the inorganic film made of SiO, SiON, SiN or the like is formed by a plasma CVD method, an ion plating method, an ion beam method, a sputtering method, or the like, so that the one surfaces 14a, 15a, and 16a are covered with the red phosphor layer 14, the blue phosphor layer 15, and the green phosphor layer 16, the resin is further coated by using the spin coat method, the ODF, the lamirate method, or the like to cover the inorganic film, or the resin film is bonded to cover the inorganic film so that the sealing film can be formed.

Due to the sealing film, it is possible to prevent the oxygen or the moisture from the outside to be mixed with the red phosphor layer 14, the blue phosphor layer 15, and the green phosphor layer 16, and thus it is possible to reduce the deterioration of the red phosphor layer 14, the blue phosphor layer 15, and the green phosphor layer 16. Additionally, when the fluorescent substrate 10 is applied to the display device, it is possible to prevent the oxygen or the moisture included in the red phosphor layer 14, the blue phosphor layer 15, and the green phosphor layer 16 to reach the liquid crystal layer, the inorganic EL element, the organic EL element, or the like to deteriorate the liquid crystal layer, the inorganic EL element, the organic EL element, or the like.

### (Planarizing Film)

Additionally, the planarizing film may be provided so as to cover the surface on the opposite side of the surface which is in contact with the red phosphor layer 14, the blue phosphor layer 15, and the green phosphor layer 16 in the sealing film.

The planarizing film can be formed by using the materials according to the related art. Examples of the planarizing film include inorganic materials such as silicon oxide, silicon nitride, or tantalum oxide, and organic materials such as polyimide, an acrylic resin, and a resist material. Examples of the forming methods of the planarizing film include dry processes such as the CVD method, and the vacuum deposition method, and wet processes such as the spin coat method, but the materials and the forming methods are not limited to the present embodiment. Further, the planarizing film may have any of the single layer structure or the multilayered structure.

Accordingly, when the fluorescent substrate 10 is combined with the organic light source or the liquid crystal layer, it is possible to prevent a distance to be generated between the fluorescent substrate 10 and the organic light source or the liquid crystal layer, and it is possible to enhance the adhesive property between the fluorescent substrate 10 and the organic light source or the liquid crystal layer.

In the fluorescent substrate 10, the distance d₁ between the red sub-pixel 12R and the blue sub-pixel 12B, the distance d₂ between the blue sub-pixel 12B and the green sub-pixel 12G, and the distance d₃ between the green sub-pixel 12G and the red sub-pixel 12R satisfy the relationship of d₁>d₂>d₃. That is, in the fluorescent substrate 10, since the distance d₁ between the red sub-pixel 12R and the blue sub-pixel 12B is greater than the other distances of the distance d₂ between the blue sub-pixel 12B and the green sub-pixel 12G, and the distance d₃ between the green sub-pixel 12G and the red sub-pixel 12R, the excitation light that is emitted from the excitation light source and to be incident on the red sub-pixel 12R can be prevented from being incident on the blue sub-pixel 12B. Therefore, it is possible to prevent the blue emission light from the blue sub-pixel 12B from being mixed with the red emission light from the red sub-pixel 12R to fade the color in the red display. Accordingly, the light amount emitted from the red sub-pixel 12R can be prevented from decreasing, and the light emission efficiency of the display device using the fluorescent substrate 10 can be prevented from decreasing.

### (2) Second Embodiment

FIG. 2 is a schematic cross-sectional view illustrating a fluorescent substrate according to a second embodiment.

In FIG. 2, like elements of the fluorescent substrate 10 illustrated in FIG. 1 are denoted by like reference numerals, and detailed descriptions thereof are omitted.

The difference of a fluorescent substrate 30 according to the present embodiment from the fluorescent substrate 10 according to the first embodiment is that if a distance between the red sub-pixel 12R and the blue sub-pixel 12B, that is, a distance between the red phosphor layer 14 and the blue phosphor layer 15 is d₁, a distance between the blue sub-pixel 12B and the green sub-pixel 12G, that is, a distance between the blue phosphor layer 15 and the green phosphor layer 16 is d₂, a distance between the green sub-pixel 12G and the red sub-pixel 12R, that is, a distance between the green phosphor layer 16 and the red phosphor layer 14 is d₃, the distances d₁, d₂, and d₃ satisfy the relationship of d₁>d₂=d₃.

In FIG. 2, the fluorescent substrate is formed so that the blue sub-pixel 12B approaches the green sub-pixel 12G side (the other pixel side which is not provided in the red sub-pixel 12R). Accordingly, the distance d₁ between the blue sub-pixel 12B and the red sub-pixel 12R on the other side becomes wider than the other.

In the fluorescent substrate 30, since the distance d₁ between the red sub-pixel 12R and the blue sub-pixel 12B is greater than the other distances of the distance d₂ between the blue sub-pixel 12B and the green sub-pixel 12G and the distance d₃ between the green sub-pixel 12G and the red sub-pixel 12R, the excitation light that is emitted from the excitation light source and to be incident on the red sub-pixel 12R can be prevented from being incident on the blue sub-pixel 12B. Therefore, it is possible to prevent the blue emission light from the blue sub-pixel 12B from being mixed with the red emission light from the red sub-pixel 12R to fade the color in the red display. Accordingly, the light amount emitted from the red sub-pixel 12R can be prevented from decreasing, and the light emission efficiency of the display device using the fluorescent substrate 30 can be prevented from decreasing.

### (3) Third Embodiment

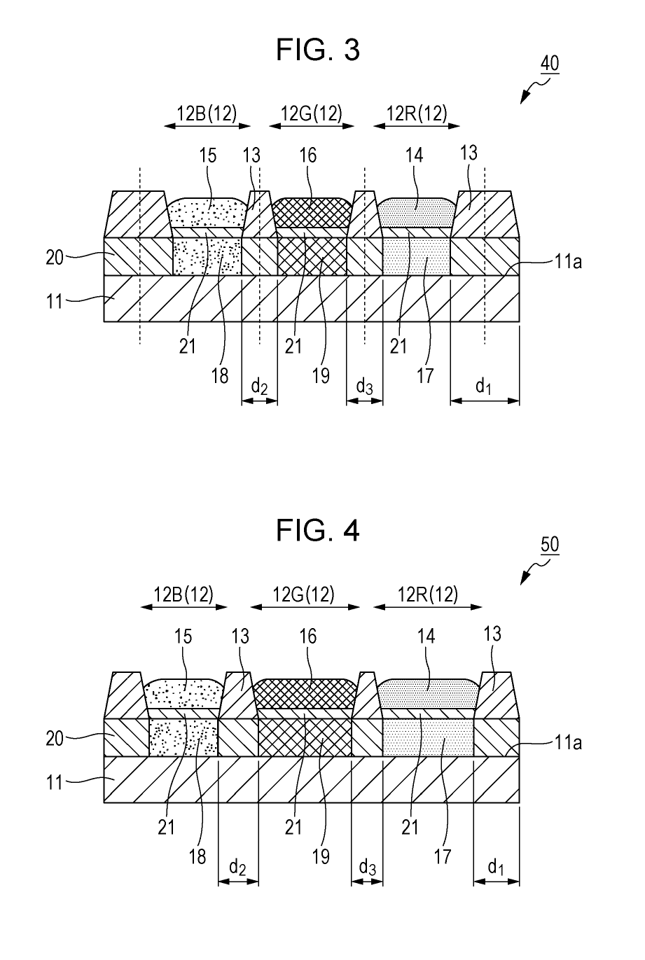

FIG. 3 is a schematic cross-sectional view illustrating a fluorescent substrate according to a third embodiment.

In FIG. 3, like elements of the fluorescent substrate 10 illustrated in FIG. 1 are denoted by like reference numerals, and detailed descriptions thereof are omitted.

The difference of a fluorescent substrate 40 according to the present embodiment from the fluorescent substrate 10 according to the first embodiment is that if a distance between the red sub-pixel 12R and the blue sub-pixel 12B, that is, a distance between the red phosphor layer 14 and the blue phosphor layer 15 is d₁, a distance between the blue sub-pixel 12B and the green sub-pixel 12G, that is, a distance between the blue phosphor layer 15 and the green phosphor layer 16 is d₂, a distance between the green sub-pixel 12G and the red sub-pixel 12R, that is, a distance between the green phosphor layer 16 and the red phosphor layer 14 is d₃, the distances d₁, d₂, and d₃ satisfy the relationship of d₁>d₂=d₃.

In FIG. 3, the fluorescent substrate is formed so that the blue sub-pixel 12B approaches the green sub-pixel 12G side and also the red sub-pixel 12R approaches the green sub-pixel 12G side (the other pixel side which is not provided in the blue sub-pixel 12B). Accordingly, the distance d₁ between the blue sub-pixel 12B and the red sub-pixel 12R on the other side becomes wider than the other.

In the fluorescent substrate 40, since the distance d₁ between the red sub-pixel 12R and the blue sub-pixel 12B is greater than the other distances of the distance d₂ between the blue sub-pixel 12B and the green sub-pixel 12G and the distance d₃ between the green sub-pixel 12G and the red sub-pixel 12R, the excitation light that is emitted from the excitation light source and to be incident on the red sub-pixel 12R can be prevented from being incident on the blue sub-pixel 12B. Therefore, it is possible to prevent the blue emission light from the blue sub-pixel 12B from being mixed with the red emission light from the red sub-pixel 12R to fade the color in the red display. Accordingly, the light amount emitted from the red sub-pixel 12R can be prevented from decreasing, and the light emission efficiency of the display device using the fluorescent substrate 40 can be prevented from decreasing.

### (4) Fourth Embodiment

FIG. 4 is a schematic cross-sectional view illustrating a fluorescent substrate according to a fourth embodiment.

In FIG. 4, like elements of the fluorescent substrate 10 illustrated in FIG. 1 are denoted by like reference numerals, and detailed descriptions thereof are omitted.

The difference of a fluorescent substrate 50 according to the present embodiment from the fluorescent substrate 10 according to the first embodiment is that if a distance between the red sub-pixel 12R and the blue sub-pixel 12B, that is, a distance between the red phosphor layer 14 and the blue phosphor layer 15 is d₁, a distance between the blue sub-pixel 12B and the green sub-pixel 12G, that is, a distance between the blue phosphor layer 15 and the green phosphor layer 16 is d₂, a distance between the green sub-pixel 12G and the red sub-pixel 12R, that is, a distance between the green phosphor layer 16 and the red phosphor layer 14 is d₃, the distances d₁, d₂, and d₃ satisfy the relationship of d₁=d₂>d₃.

In the fluorescent substrate 50, though the distance d₁ between the red sub-pixel 12R and the blue sub-pixel 12B is equal to the distance d₂ between the blue sub-pixel 12B and the green sub-pixel 12G, but greater than the distance d₃ between the green sub-pixel 12G and the red sub-pixel 12R, the excitation light that is emitted from the excitation light source and to be incident on the red sub-pixel 12R can be prevented from being incident on the blue sub-pixel 12B. Therefore, it is possible to prevent the blue emission light from the blue sub-pixel 12B from being mixed with the red emission light from the red sub-pixel 12R to fade the color in the red display. Accordingly, the light amount emitted from the red sub-pixel 12R can be prevented from decreasing, and the light emission efficiency of the display device using the fluorescent substrate 50 can be prevented from decreasing.

### (5) Fifth Embodiment

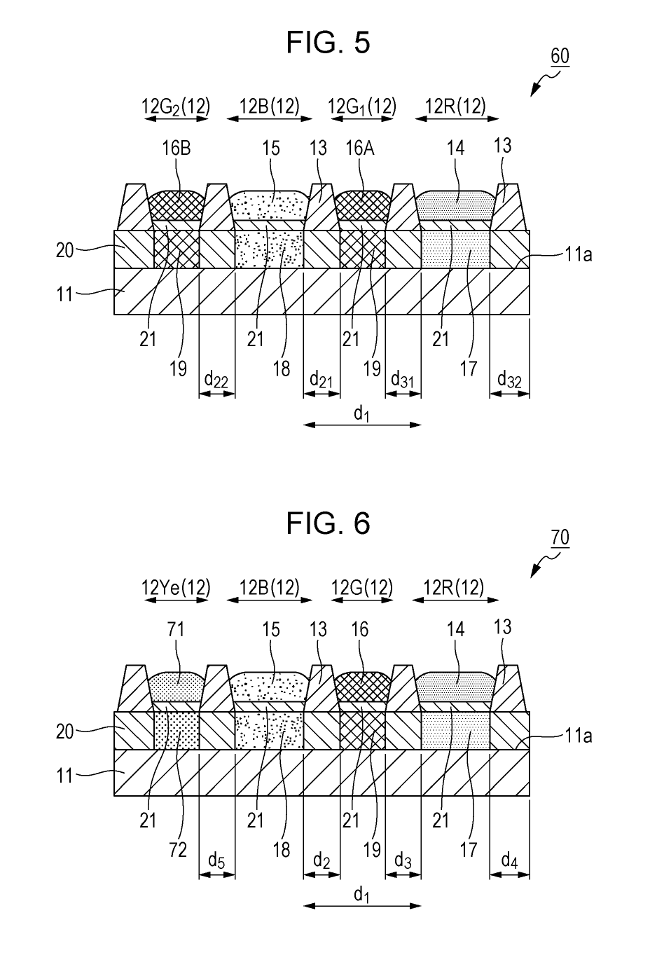

FIG. 5 is a schematic cross-sectional view illustrating a fluorescent substrate according to a fifth embodiment.

In FIG. 5, like elements of the fluorescent substrate 10 illustrated in FIG. 1 are denoted by like reference numerals, and detailed descriptions thereof are omitted.

The difference of a fluorescent substrate 60 according to the present embodiment from the fluorescent substrate 10 according to the first embodiment is that a green sub-pixel that performs display by the green light is divided into a green sub-pixel 12G₁ and a green sub-pixel 12G₂, and the green sub-pixel 12G₁ and the green sub-pixel 12G₂ each are interposed between the red sub-pixel 12R and the blue sub-pixel 12B.

Further, the difference of the fluorescent substrate 60 according to the present embodiment from the fluorescent substrate 10 according to the first embodiment is that if a distance between the red sub-pixel 12R and the blue sub-pixel 12B, that is, a distance between the red phosphor layer 14 and the blue phosphor layer 15 is d₁, a distance between the blue sub-pixel 12B and the green sub-pixel 12G₁, that is, a distance between the blue phosphor layer 15 and a green phosphor layer 16A is d₂₁, a distance between the blue sub-pixel 12B and the green sub-pixel 12G₂, that is, a distance between the blue phosphor layer 15 and a green phosphor layer 16B is d₂₂, a distance between the green sub-pixel 12G₁ and the red sub-pixel 12R, that is, a distance between the green phosphor layer 16A and the red phosphor layer 14 is d₃₁, and a distance between the green sub-pixel 12G₂ and the red sub-pixel 12R, that is, a distance between the green phosphor layer 16B and the red phosphor layer 14 is d₃₂, the distances d₁, d₂₁, d₂₂, d₃₁, and d₃₂ satisfy the relationship of d₁>d₂₁=d₂₂=d₃₁=d₃₂.

In the fluorescent substrate 60, since the distance d₁ between the red sub-pixel 12R and the blue sub-pixel 12B is greater than the other distances of the distance d₂₁ between the blue sub-pixel 12B and the green sub-pixel 12G₁, the distance d₂₂ between the blue sub-pixel 12B and the green sub-pixel 12G₂, the distance d₃₁ between the green sub-pixel 12G₁ and the red sub-pixel 12R, and the distance d₃₂ between the green sub-pixel 12G₂ and the red sub-pixel 12R, the excitation light that is emitted from the excitation light source and to be incident on the red sub-pixel 12R can be prevented from being incident on the blue sub-pixel 12B. Therefore, it is possible to prevent the blue emission light from the blue sub-pixel 12B from being mixed with the red emission light from the red sub-pixel 12R to fade the color in the red display. Accordingly, the light amount emitted from the red sub-pixel 12R can be prevented from decreasing, and the light emission efficiency of the display device using the fluorescent substrate 60 can be prevented from decreasing.

### (6) Sixth Embodiment

FIG. 6 is a schematic cross-sectional view illustrating a fluorescent substrate according to a sixth embodiment.

In FIG. 6, like elements of the fluorescent substrate 10 illustrated in FIG. 1 are denoted by like reference numerals, and detailed descriptions thereof are omitted.

The difference of a fluorescent substrate 70 according to the present embodiment from the fluorescent substrate 10 according to the first embodiment is that each of the pixels 12 is formed of the red sub-pixel 12R that performs display by the red light, the blue sub-pixel 12B that performs display by the blue light, the green sub-pixel 12G that performs display by the green light, a yellow sub-pixel 12Ye that performs display by the yellow light, that a yellow phosphor layer 71 that emits yellow light (fluorescent light) incident from the excitation light source (not illustrated) is provided, that a yellow color filter 72 is provided in the yellow sub-pixel 12Ye between the substrate 11 and the red phosphor layer 14, the blue phosphor layer 15, the green phosphor layer 16, and the yellow phosphor layer 71, and that the green sub-pixel 12G and the yellow sub-pixel 12Ye are respectively interposed between the red sub-pixel 12R and the blue sub-pixel 12B.

Further, the difference of the fluorescent substrate 70 according to the present embodiment from the fluorescent substrate 10 according to the first embodiment is that if a distance between the red sub-pixel 12R and the blue sub-pixel 12B, that is, a distance between the red phosphor layer 14 and the blue phosphor layer 15 is d₁, a distance between the blue sub-pixel 12B and the green sub-pixel 12G, that is, a distance between the blue phosphor layer 15 and the green phosphor layer 16 is d₂, a distance between the green sub-pixel 12G and the red sub-pixel 12R, that is, a distance between the green phosphor layer 16 and the red phosphor layer 14 is d₃, a distance between the red sub-pixel 12R and the yellow sub-pixel 12Ye, that is, a distance between the red phosphor layer 14 and the yellow phosphor layer 71 is d₄, and a distance between the yellow sub-pixel 12Ye and the blue sub-pixel 12B, that is, a distance between the yellow phosphor layer 71 and the blue phosphor layer 15 is d₅, the distances d₁, d₂, d₃, d₄, and d₅ satisfy the relationship of d₁>d₂=d₃=d₄=d₅.

In the fluorescent substrate 70, since the distance d₁ between the red sub-pixel 12R and the blue sub-pixel 12B is greater than the other distances of the distance d₂ of the blue sub-pixel 12B and the green sub-pixel 12G, the distance d₃ between the green sub-pixel 12G and the red sub-pixel 12R, the distance d₄ between the red sub-pixel 12R and the yellow sub-pixel 12Ye, and the distance d₅ between the yellow sub-pixel 12Ye and the blue sub-pixel 12B, the excitation light that is emitted from the excitation light source and to be incident on the red sub-pixel 12R can be prevented from being incident on the blue sub-pixel 12B. Therefore, it is possible to prevent the blue emission light from the blue sub-pixel 12B from being mixed with the red emission light from the red sub-pixel 12R to fade the color in the red display. Accordingly, the light amount emitted from the red sub-pixel 12R can be prevented from decreasing, and the light emission efficiency of the display device using the fluorescent substrate 70 can be prevented from decreasing.

### (7) Seventh Embodiment

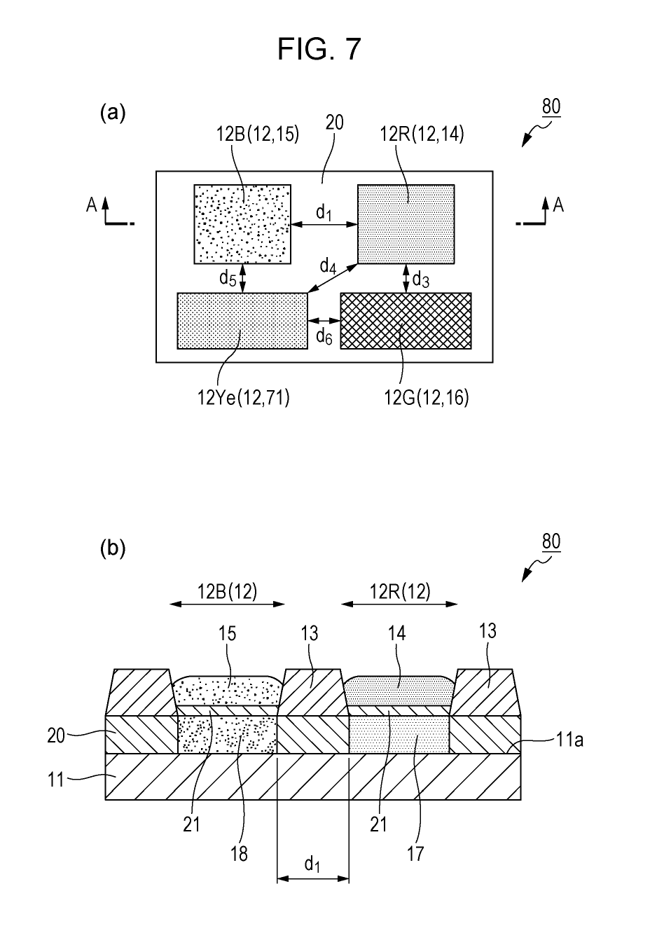

FIG. 7 is a schematic diagram illustrating a fluorescent substrate according to a seventh embodiment, (a) is a plan view, (b) is a cross-sectional view taken along the line A-A of (a).

In FIG. 7, like elements of the fluorescent substrate 10 illustrated in FIG. 1 are denoted by like reference numerals, and detailed descriptions thereof are omitted.

The difference of a fluorescent substrate 80 according to the present embodiment from the fluorescent substrate 10 according to the first embodiment is that each of the pixels 12 is formed of the red sub-pixel 12R that performs display by the red light, the blue sub-pixel 12B that performs display by the blue light, the green sub-pixel 12G that performs display by the green light, and the yellow sub-pixel 12Ye that performs display by the yellow light, that the yellow phosphor layer 71 that emits the yellow light (fluorescent light) by the excitation light that is incident from the excitation light source (not illustrated) is provided, and that the red sub-pixel 12R, the blue sub-pixel 12B, the green sub-pixel 12G, and the yellow sub-pixel 12Ye are arranged in a matrix shape in one of the pixels 12 in the planar view of the fluorescent substrate 80.

Further, the difference of the fluorescent substrate 80 according to the present embodiment from the fluorescent substrate 10 according to the first embodiment is that if a distance between the red sub-pixel 12R and the blue sub-pixel 12B, that is, a distance between the red phosphor layer 14 and the blue phosphor layer 15 is d₁, a distance between the green sub-pixel 12G and the red sub-pixel 12R, that is, a distance between the green phosphor layer 16 and the red phosphor layer 14 is d₃, a distance between the red sub-pixel 12R and the yellow sub-pixel 12Ye, that is, a distance between the red phosphor layer 14 and the yellow phosphor layer 71 is d₄, a distance between the yellow sub-pixel 12Ye and the blue sub-pixel 12B, that is, a distance between the yellow phosphor layer 71 and the blue phosphor layer 15 is d₅, and a distance between the yellow sub-pixel 12Ye and the green phosphor layer 16, that is, a distance between the yellow phosphor layer 71 and the green phosphor layer 16 is d₆, the distances d₁, d₃, d₄, d₅, and d₆ satisfy the relationship of d₁>d₄>d₃=d₅=d₆.

In the fluorescent substrate 80, since the distance d₁ between the red sub-pixel 12R and the blue sub-pixel 12B is greater than the other distances of the distance d₃ of the green sub-pixel 12G and the red sub-pixel 12R, the distance d₄ between the red sub-pixel 12R and the yellow sub-pixel 12Ye, the distance d₅ between the yellow sub-pixel 12Ye and the blue sub-pixel 12B, and the distance d₆ between the yellow sub-pixel 12Ye and the green phosphor layer 16, the excitation light that is emitted from the excitation light source and to be incident on the red sub-pixel 12R can be prevented from being incident on the blue sub-pixel 12B. Therefore, it is possible to prevent the blue emission light from the blue sub-pixel 12B from being mixed with the red emission light from the red sub-pixel 12R to fade the color in the red display. Accordingly, the light amount emitted from the red sub-pixel 12R can be prevented from decreasing, and the light emission efficiency of the display device using the fluorescent substrate 80 can be prevented from decreasing.

### (8) Eighth Embodiment

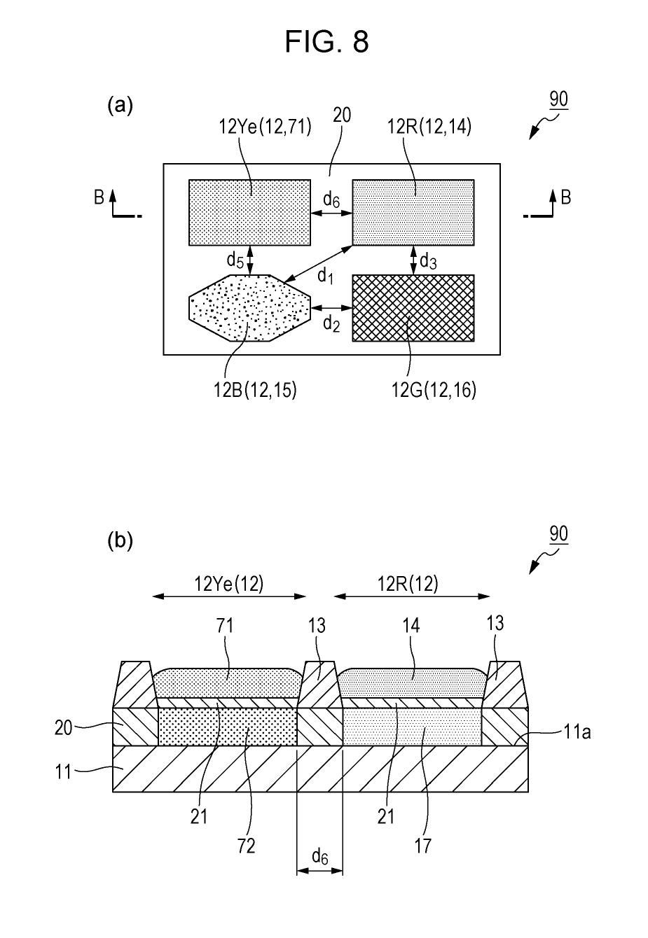

FIG. 8 is a schematic diagram illustrating a fluorescent substrate according to an eighth embodiment, (a) is a plan view, (b) is a cross-sectional view taken along the line B-B of (a).

In FIG. 8, like elements of the fluorescent substrate 10 illustrated in FIG. 1 are denoted by like reference numerals, and detailed descriptions thereof are omitted.

The difference of a fluorescent substrate 90 according to the present embodiment from the fluorescent substrate 10 according to the first embodiment is that each of the pixels 12 is formed of the red sub-pixel 12R that performs display by the red light, the blue sub-pixel 12B that performs display by the blue light, the green sub-pixel 12G that performs display by the green light, and the yellow sub-pixel 12Ye that performs display by the yellow light, that the yellow phosphor layer 71 that emits the yellow light (fluorescent light) by the excitation light that is incident from the excitation light source (not illustrated) is provided, that the red sub-pixel 12R, the blue sub-pixel 12B, the green sub-pixel 12G, and the yellow sub-pixel 12Ye are arranged in a matrix shape in one of the pixels 12 in the planar view of the fluorescent substrate 80, and that the blue sub-pixel 12B is provided in a diamond shape in the planar view.

Further, the difference of the fluorescent substrate 80 according to the present embodiment from the fluorescent substrate 10 according to the first embodiment is that if a distance between the red sub-pixel 12R and the blue sub-pixel 12B, that is, a distance between the red phosphor layer 14 and the blue phosphor layer 15 is d₁, a distance between the blue sub-pixel 12B and the green sub-pixel 12G, that is, a distance between the blue phosphor layer 15 and the green phosphor layer 16 is d₂, a distance between the green sub-pixel 12G and the red sub-pixel 12R, that is, a distance between the green phosphor layer 16 and the red phosphor layer 14 is d₃, a distance between the yellow sub-pixel 12Ye and the blue sub-pixel 12B, that is, a distance between the yellow phosphor layer 71 and the blue phosphor layer 15 is d₅, and a distance between the yellow sub-pixel 12Ye and the green phosphor layer 16, that is, a distance between the yellow phosphor layer 71 and the green phosphor layer 16 is d₆, the distances d₁, d₂, d₃, d₅, and d₆ satisfy the relationship of d₁>d₂=d₆>d₃=d₅.

In the present embodiment, in addition to the red sub-pixel 12R, the blue sub-pixel 12B, and the green sub-pixel 12G, each of the pixels 12 includes the yellow sub-pixel 12Ye as a fourth color sub-pixel that performs display of a fourth color different from the red light, the blue light, and the green light.

The fourth color is not especially limited, as long as the fourth color does not fade the red light in the blue light direction.

If a main wavelength of the red light displayed by the red sub-pixel 12R is λᵣ, a main wavelength of the blue light displayed by the blue sub-pixel 12B is λ_{b}, and a main wavelength of the fourth light displayed by the fourth color sub-pixel is λ₄, it is preferable to satisfy the relationship of λ_{b}<λ₄<λᵣ.

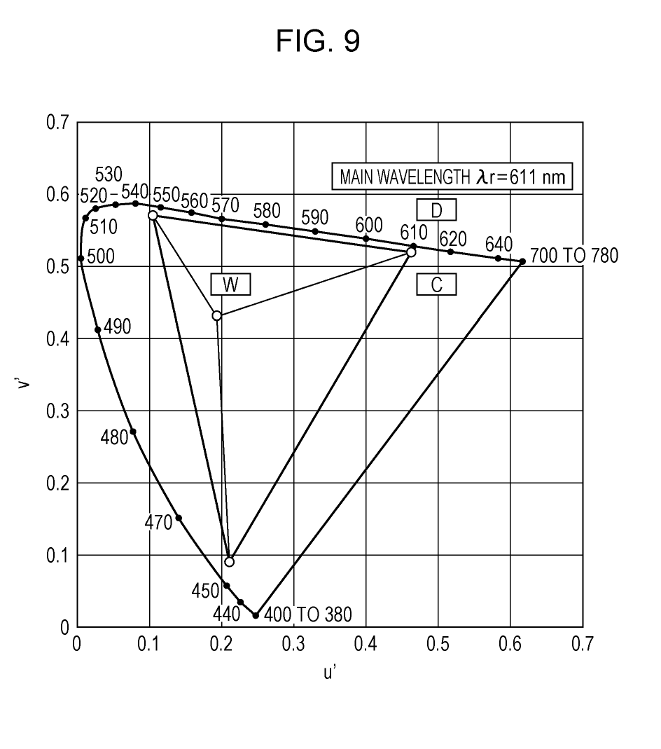

The main wavelengths of the sub-pixels of the respective colors are determined as follows, as illustrated in FIG. 9.

First, a white point W and a chromacity point C emitted from a phosphor pixel are plotted.

A point at which a straight line connecting the two points and a spectrum locus intersect with each other (intersection point) is set to be D. A wavelength of a monochromatic stimulus of the intersection point D is set to be the main wavelength.

Further, if the main wavelength of the red light displayed by the red sub-pixel 12R is λᵣ, the main wavelength of the green light displayed by the green sub-pixel 12G is λ_{g}, and the main wavelength of the fourth color light displayed by the fourth color sub-pixel light is λ₄, it is preferable to satisfy the relationship of λ_{g}<λ₄<λᵣ.

Additionally, if the main wavelength of the green light displayed by the green sub-pixel 12G is 2, and the main wavelength of the fourth color light displayed by the fourth color sub-pixel light is λ₄, it is preferable to satisfy the relationship of λ₄=λ_{g}.

That is, it is preferable that the fourth color light that satisfies the relationship be light ranging from orange to be yellow or yellow green to green.

According to the fluorescent substrate 90, since the distance d₁ between the red sub-pixel 12R and the blue sub-pixel 12B is greater than the other distances of the distance d₂ between the blue sub-pixel 12B and the green sub-pixel 12G, the distance d₃ between the green sub-pixel 12G and the red sub-pixel 12R, the distance d₅ between the yellow sub-pixel 12Ye and the blue sub-pixel 12B, and the distance d₆ between the yellow sub-pixel 12Ye and the green phosphor layer 16, the excitation light that is emitted from the excitation light source and to be incident on the red sub-pixel 12R can be prevented from being incident on the blue sub-pixel 12B. Therefore, it is possible to prevent the blue emission light from the blue sub-pixel 12B from being mixed with the red emission light from the red sub-pixel 12R to fade the color in the red display. Accordingly, the light amount emitted from the red sub-pixel 12R can be prevented from decreasing, and the light emission efficiency of the display device using the fluorescent substrate 90 can be prevented from decreasing.

### [Display Device]

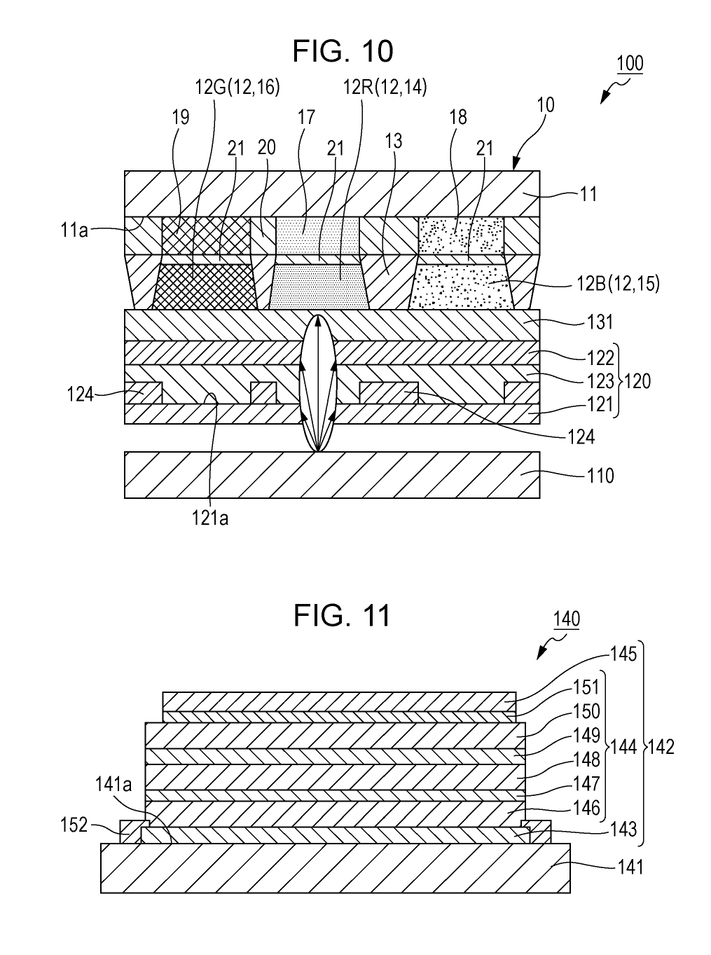

FIG. 10 is a schematic cross-sectional view illustrating a display device according to an embodiment.

In FIG. 10, like elements of the fluorescent substrate 10 illustrated in FIG. 1 are denoted by like reference numerals, and detailed descriptions thereof are omitted.

A fluorescent substrate 100 according to the present embodiment is mainly formed of the fluorescent substrate 10, a light source 110 having directivity that emits excitation light that is radiated to each of the pixels 12 of the fluorescent substrate 10, and an excitation light amount modulation layer 120 that is provided to overlap the fluorescent substrate 10, and adjusts the excitation light incident on each of the pixels 12.

The excitation light amount modulation layer 120 is formed of the liquid crystal elements, includes a pair of light polarizing plates 121 and 122, a pair of transparent electrodes (not illustrated), a pair of oriented films (not illustrated), and a substrate (not illustrated), and has a structure in which a liquid crystal layer 123 is interposed between the pair of oriented films.

The excitation light amount modulation layer 120 is formed so that the voltage applied to the liquid crystal layer can be controlled for each pixel by using the pair of electrodes, and the transmittance of the light emitted from the entire surface of the light source 110 is controlled for each pixel. That is, the excitation light amount modulation layer 120 has a function as an optical shutter that selectively transmits light from the light source 110 for each pixel. Further, it is possible to control both of the excitation light amount modulation layer 120 and the light source 110 to be turned ON/OFF.

Further, the fluorescent substrate 10 and the excitation light amount modulation layer 120 are stacked with a sealing substrate 131 interposed therebetween.

Further, light shielding layers (black matrix) 124 are provided on a surface 121a on the liquid crystal layer 123 side of a light polarizing plate 121. Pixel opening portions of the excitation light amount modulation layer 120 are formed by the light shielding layers 124 so that the pixel opening portions of the fluorescent substrate 10 and central portions substantially coincide.

As the light source 110, an ultraviolet LED, a blue LED, an inorganic ultraviolet light emitting EL element, an inorganic blue light emitting EL element, an organic ultraviolet light emitting EL element, an organic blue light emitting EL element, and the like according to the related art are used, but the light source is not limited to the embodiment, and it is possible to use a light source manufactured by materials according to the related art, and manufacturing methods according to the related art.

Here, as the ultraviolet light, the emission light having a main emission light peak of 360 nm to 410 nm is preferable, and as the blue light, the emission light having a main emission light peak of 410 nm to 470 nm is preferable.

Hereinafter, emission light elements that can be appropriately used as the light source 110 are described.

### (Organic EL Element)

FIG. 11 is a schematic cross-sectional view illustrating an organic EL element substrate that configures the light source 110 according to an embodiment.

An organic EL element substrate 140 is mainly formed of a substrate 141, and an organic EL element 142 provided on one surface 141a of the substrate 141.

The organic EL element 142 is mainly formed of the first electrode 143, the organic EL layer 144, and the second electrode 145, which are sequentially provided on the one surface 141a of the substrate 141. That is, the organic EL element 142 includes a pair of electrodes made with the first electrode 143 and a second electrode 125 and the organic EL layer 144 interposed between the pair of electrodes on the one surface 141a of the substrate 141.

The first electrode 143 and the second electrode 145 function as an anode or a cathode of the organic EL element 142 in pairs.

The optical length between the first electrode 143 and the second electrode 145 is adjusted so as to configure the microresonator structure (microcavity structure).

The organic EL layer 144 is formed of a hole injecting layer 146, a hole transporting layer 147, an organic light emitting layer 148, a hole preventing layer 149, an electron transporting layer 150, and an electron injecting layer 151, which are sequentially stacked from the first electrode 143 side to the second electrode 145 side.

The hole injecting layer 146, the hole transporting layer 147, the organic light emitting layer 148, the hole preventing layer 149, the electron transporting layer 150, and the electron injecting layer 151 may have any one of a single layer structure or a multiple layered structure, respectively. Further, the hole injecting layer 146, the hole transporting layer 147, the organic light emitting layer 148, the hole preventing layer 149, the electron transporting layer 150, and the electron injecting layer 151 may be any one of an organic thin film or an inorganic thin film, respectively.

The hole injecting layer 146 effectively injects holes from a first electrode 143.

The hole transporting layer 147 effectively transports holes to the organic light emitting layer 148. The electron transporting layer 150 effectively transports electrons to the organic light emitting layer 148.

The electron injecting layer 151 effectively injects electrons from a second electrode 145.

The hole injecting layer 146, the hole transporting layer 147, the electron transporting layer 150, and the electron injecting layer 151 correspond to carrier injecting and transporting layers.

In addition, the organic EL element 142 is not limited to the configurations, and even if an organic EL layer 144 may have a single layer structure of an organic light emitting layer, or may be a multilayered structure of the organic light emitting layer and the carrier injecting and transporting layer. As the configuration of the organic EL element 142, the following are specifically included.

(1) A configuration in which only the organic light emitting layer is provided between the first electrode 143 and the second electrode 145

(2) A configuration in which the hole transporting layer and the organic light emitting layer are stacked in this sequence from the first electrode 143 side to the second electrode 145 side

(3) A configuration in which the organic light emitting layer and the electron transporting layer are stacked in this sequence from the first electrode 143 side to the second electrode 145 side

(4) A configuration in which the hole transporting layer, the organic light emitting layer, and the electron transporting layer are stacked in this sequence from the first electrode 143 side to the second electrode 145 side

(5) A configuration in which the hole injecting layer, the hole transporting layer, the organic light emitting layer, and the electron transporting layer are stacked in this sequence from the first electrode 143 side to the second electrode 145 side

(6) A configuration in which the hole injecting layer, the hole transporting layer, the organic light emitting layer, the electron transporting layer, and the electron injecting layer are stacked in this sequence from the first electrode 143 side to the second electrode 145 side

(7) A configuration in which the hole injecting layer, the hole transporting layer, the organic light emitting layer, the hole preventing layer, and the electron transporting layer are stacked in this sequence from the first electrode 143 side to the second electrode 145 side

(8) A configuration in which the hole injecting layer, the hole transporting layer, the organic light emitting layer, the hole preventing layer, the electron transporting layer, and the electron injecting layer are stacked in this sequence from the first electrode 143 side to the second electrode 145 side

(9) A configuration in which the hole injecting layer, the hole transporting layer, the electron preventing layer, the organic light emitting layer, the hole preventing layer, the electron transporting layer, and the electron injecting layer are stacked in this sequence from the first electrode 143 side to the second electrode 145 side

The respective layers of the organic light emitting layer, the hole injecting layer, the hole transporting layer, the hole preventing layer, the electron preventing layer, the electron transporting layer, and the electron injecting layer may have any one of the single layer structure and the multiple layer structure. Further, the respective layers of the organic light emitting layer, the hole injecting layer, the hole transporting layer, the hole preventing layer, the electron preventing layer, the electron transporting layer, and the electron injecting layer may be any one of the organic thin film or the inorganic thin film, respectively.

Further, an edge cover 152 is formed to cover the cross section of the first electrode 143. That is, in order to prevent the leakage from occurring between the first electrode 143 and the second electrode 145, the edge cover 152 is provided between the first electrode 143 and the second electrode 145 so as to cover an edge portion of the first electrode 143 formed on the one surface 141a of the substrate 141.

Hereinafter, respective constituent members configuring the organic EL element substrate 140 and the forming methods are specifically described, but the present embodiment is not limited to the constituent members and the forming methods.

Examples of the substrate 141 include inorganic material substrates made of glass, quartz, or the like, plastic substrates made of polyethylene terephthalate, polycarbazole, polyimide, or the like, insulating substrates such as ceramic substrates made of alumina or the like, metal substrates made of aluminum (Al), iron (Fe), or the like, substrates obtained by coating insulating materials made of silicon oxide (SiO₂), organic insulating materials, or the like on surfaces on the substrates, substrates obtained by performing insulating processing on the surfaces of the metal substrates made of aluminum or the like in a method of anodic oxidation, or the like, but the present embodiment is not limited to the substrates. Among these substrates, it is preferable to use plastic substrates or metal substrates since it is possible to form a bent portion or a folded portion without stress.

Additionally, the substrates obtained by coating the inorganic materials on the plastic substrates, and the substrates obtained by coating the inorganic insulating materials on the metal substrates are preferable. The deterioration of the organic EL (especially, it is known that the organic EL is deteriorated only by little moisture) caused by the penetration of the moisture, which is the biggest problem when the plastic substrate is used as the substrate of the organic EL element substrate can be solved by using the substrates obtained by coating the inorganic materials. Further, the leakage (short) (it is known that the leakage (short) in the current in the protruding pixel portion frequently occurs since the film thickness of the organic EL layer is extremely thin at approximately 100 nm to 200 nm) caused by the projection of the metal substrates which is the biggest problem when the metal substrates are used as the substrates of the organic EL element substrates can be solved.

Further, when the TFT is formed, it is preferable to use a substrate that does not melt or deform at a temperature of 500° C. or less, as with the substrate 141. Further, since the general metal substrates have different coefficients of thermal expansion from glass, the TFT on the metal substrate may not be formed by the production apparatus according to the related art. However, the metal substrates made of the iron-nickel-based alloy having coefficients of linear thermal expansion lower than 1×10⁻⁵/° C. can be used so that the coefficients of linear thermal expansion are matched to glass. Therefore, it is possible to form the TFT on the metal substrate by using the manufacturing apparatus according to the related art at a low cost.

Further, in the case of the plastic substrate, since a heat resistant temperature is extremely low, it is possible to form the TFT by transfer on the plastic substrate by forming the TFT on the glass substrate, and then transferring the TFT on the glass substrate to the plastic substrate.

Additionally, when the emission light from the organic EL layer 144 is ejected from the opposite side of the substrate 141, the substrate has no restriction, but when the emission light from the organic EL layer 144 is ejected from the substrate 141 side, transparent or translucent substrates are required in order to eject the emission light from the organic EL layer 144 to the outside.

The TFT formed on the substrate 141 is formed on the one surface 141a of the substrate 141 in advance before the organic EL element 142 is formed, and functions as an element for switching pixels and an element for driving the organic EL elements.

The TFT according to the present embodiment may be the TFT according to the related art. Further, in substitution for the TFT, a metal-insulator-metal (MIM) diode can be used.

The TFT can be used in an active driving-type organic EL display device, and an organic EL display device can be formed by the materials and the forming methods according to the related art.

Examples of materials of the active layer configuring the TFT include inorganic semiconductor materials such as amorphous silicon, polycrystal silicon (polysilicon), microcrystalline silicon, and cadmium selenide, oxide semiconductor materials such as zinc oxide and iridium oxide-gallium oxide-zinc oxide, and organic semiconductor materials such as a polythiophene derivative, thiophene oligomer, a poly (p-pherylene vinylene) derivative, naphthacene, and pentacene. Further, examples of the structures of the TFT include a staggered type, a reverse-staggered type, a top gate type, and a coplanar type.

Examples of forming methods of the active layer that configures the TFT include (1) a method of performing ion-doping on the impurity to amorphous silicon formed by the plasma-enhanced chemical vapor deposition (PECVD) method, (2) a method of forming amorphous silicon by the low pressure chemical vapor deposition (LPCVD) method by using a silane (SiH₄) gas, obtaining polysilicon by crystallizing amorphous silicon by the solid phase epitaxy method, and performing ion-doping by the ion plantation method, (3) a method of forming amorphous silicon by the LPCVD method using Si₂H₆ gas and the PECVD method using SiH₄ gas, perform annealing by laser such as excimer laser, obtaining polysilicon by crystallizing amorphous silicon, and performing ion-doping (low temperature process), (4) a method of forming a polysilicon layer by the LPCVD method or the PECVD method, forming the gate insulating film by thermal oxidation at 1,000° C. or higher, forming n⁺ polysilicon gate electrodes, and then performing ion-doping (high temperature process), (5) a method of forming the organic semiconductor material by the ink-jet method or the like, and (6) a method of obtaining single crystal of the organic semiconductor material.

The gate insulating film configuring the TFT according to the present embodiment can be formed by using the materials according to the related art. Examples of the gate insulating film include the insulating film made of SiO₂ formed by the PECVD method, the LPCVD method, and the like, SiO₂ obtained by performing the thermal oxidation on the polysilicon film, or the like.

Further, signal electrode lines, scanning electrode lines, common electrode lines, first driving electrodes, and second driving electrodes of the TFT according to the present embodiment can be formed by using the materials according to the related art. Examples of the materials of the signal electrode lines, the scanning electrode lines, the common electrode lines, the first driving electrodes, and the second driving electrodes include tantalum (Ta), aluminum (Al), and copper (Cu). The TFT of an organic EL element substrate 120 can be formed as described above, but the present embodiment is not limited to the constituent members and the forming methods.

Interlayer insulating films that can be used in the active driving-type organic EL display device and the organic EL display device can be formed by using the materials according to the related art. Examples of the materials of the interlayer insulating film include inorganic materials such as silicon oxide (SiO₂), silicon nitride (SiN or Si₂N₄), and tantalum oxide (TaO or Ta₂O₅), or the organic materials such as an acrylic resin, and a resist material.

Further, examples of the forming methods of the interlayer insulating film include dry processes such as a chemical vapor deposition (CVD) method or a vacuum evaporation method, and wet processes such as a spin coat method. Further, the interlayer insulating film can be patterned by the photolithographic method or the like, if necessary.

When the emission light from the organic EL element 142 is ejected from the opposite side of the substrate 141 (the second electrode 145 side), it is preferable to form the light shielding insulating film also having the light shielding property for the purpose of preventing the characteristics of the performance of the TFT from being changed by external light incident on the TFT formed on the one surface 141a of the substrate 141. Further, it is possible to combine and use the interlayer insulating film and the light shielding insulating film. Examples of the materials of the light shielding insulating film include materials obtained by dispersing pigments or dyes such as phthalocyanine or quinacrodone in the high molecular resin such as polyimide, color resist materials, black matrix materials, and inorganic insulating materials such as NiₓZn_{y}Fe₂O₄, but the present embodiment is not limited to the materials and the forming methods.

In the active driving-type organic EL display device, when the TFT or the like is formed on the one surface 141a of the substrate 141, there is a concern that unevenness is formed on the surface and defects (for example, a defect of a pixel electrode, a defect of an organic EL layer, disconnection of a second electrode, a short circuit of the first electrode and the second electrode, the decrease of withstanding voltage, or the like) of an organic EL element 82 can be generated by the unevenness. In order to prevent the defects, the planarizing film may be formed on the interlayer insulating film.

Such planarizing film can be formed by using the materials according to the related art. Examples of the materials of the planarizing film include inorganic materials such as silicon oxide, silicon nitride, and tantalum oxide, and organic materials such as polyimide, an acrylic resin, and a resist material. Examples of the forming methods of the planarizing film include the dry processes such as the CVD method, and the vacuum evaporation method, and the wet processes such as the spin coat method, but the present embodiment is not limited to the materials and the forming methods. Further, the planarizing film may have any one of the single layer structure or the multilayered structure.

The first electrode 143 and the second electrode 145 function as the anode or the cathode of the organic EL element 142. That is, when the first electrode 143 is set to be the anode, the second electrode 145 becomes the cathode, and when the first electrode 143 is set to be the cathode, the second electrode 125 becomes the anode.

As the electrode materials that form the first electrode 143 and the second electrode 145, the electrode materials according to the related art can be used. Examples of the electrode materials that form the anode include metal having a work function of 4.5 eV or higher such as gold (Au), platinum (Pt), and nickel (Ni), and transparent electrode materials such as an oxide (ITO) made of iridium (In) and tin (Sn), an oxide (SnO₂) made of tin (Sn), and an oxide (IZO) made of iridium (In) and zinc (Zn) from the view point of effectively injecting holes to the organic EL layer 144.

Further, examples of the electrode materials that form the cathode include metal having a work function of 4.5 eV or higher such as lithium (Li), calcium (Ca), cerium (Ce), barium (Ba), and aluminum (Al), and alloys including the metal such as an Mg:Ag alloy, and an Li:Al alloy from the view point of effectively injecting electrons to the organic EL layer 144.

The first electrode 143 and the second electrode 145 can be formed by the methods according to the related art such as the EB deposition method, the sputtering method, the ion plating method, and the resistance heating vapor deposition method, but the present embodiment is not limited to the materials and the forming methods. Further, the electrodes formed by the photolithographic method, and the laser peeling method can be patterned, if necessary, and the electrode directly patterned can be formed by combining with the shadow mask.

It is preferable that the film thicknesses of the first electrode 143 and the second electrode 145 are equal to or greater than 50 nm.

If the film thickness is less than 50 nm, there is a concern that the wiring resistance increases and the drive voltage increases.

When the micro cavity effect is used in the purpose of the improvement of the color purity of the display device, the improvement of the light emission efficiency, and the enhancement of the front surface brightness, if the emission light from the organic EL layer 144 is ejected from the first electrode 143 side or the second electrode 145 side, it is preferable to use the translucent electrode as the first electrode 143 or the second electrode 145.

As the material of the translucent electrode, a single body of the metal translucent electrode, or the combination of the metal translucent electrode and the transparent electrode material can be used. In particular, as the material of the translucent electrode, silver is preferable from the view point of the reflectivity and the transmittance.

It is preferable that the film thickness of the translucent electrode range from 5 nm to 30 nm. When the film thickness of the translucent electrode is less than 5 nm, the light is not sufficiently reflected, and the effect of the interference may not be sufficiently obtained. Further, if the film thickness of the translucent electrode exceeds 30 nm, there is a concern that the brightness and the light emission efficiency of the display device may be decreased due to the rapid decrease of the transmittance of the light.

Further, as the first electrode 143 or the second electrode 145, it is preferable to use an electrode having high reflectivity that reflects light. Examples of the electrodes having high reflectivity include reflective metal electrodes (reflecting electrodes) made of aluminum, silver, gold, an aluminum-lithium alloy, an aluminum-neodymium alloy, an aluminum-silicon alloy, electrodes obtained by combining the reflective metal electrode and the transparent electrodes, and the like.

For the purpose of effectively injecting charges (hole, electron) from the electrodes and transporting (injecting) the charges to the light emitting layer, an electron injecting and transporting layer is classified into the charge injecting layer (the hole injecting layer 146 and the electron injecting layer 151) and the charge transporting layer (the hole transporting layer 147 and the electron transporting layer 150). The electron injecting and transporting layer may be formed only of charge injecting and transporting materials described below, may randomly include addition agents (a donor, an acceptor, or the like), or may have a configuration in which the materials are dispersed in the high molecular material (binder resin) or the inorganic material.

As the charge injecting and transporting material, charge injecting and transporting materials for the organic EL element and for the organic photoconductor according to the related art can be used. The charge injecting and transporting material is classified into the hole injecting and transporting material and the electron injecting and transporting material, and the specific compound is exemplified below, but the present embodiment is not limited to the materials.

As the materials of the hole injecting layer 146 and the hole transporting layer 147, materials according to the related art are used, and examples of the hole injecting layer 146 and the hole transporting layer 147 include oxides such as vanadium oxide (V₂O₅) and molybdenum oxide (MoO₂) or the inorganic p-type semiconductor material; aromatic tertiary amine compounds such as a porphyrin compound, N,N′-bis(3-methylphenyl)-N,N′-bis(phenyl)-benzidine (TPD), N,N′-di(naphthalene-1-yl)-N,N′-diphenyl-benzidine (α-NPD), 4,4′,4″-tri(carbazol-9-yl)triphenylamine (TCTA), N,N-dicarbazolyl-3,5-benzene (m-CP), 4,4′-(cyclohexane-1,1-diyl)bis(N,N-di-p-tolylaniline) (TAPC), 2,2′-bis(N,N-diphenylamine)-9,9′-spirobifluorene (DPAS), N1,N1′-(biphenyl-4,4′-diyl)bis(N1-phenyl-N4,N4-di-m-tolylbenzene-1,4-diamine) (DNTPD), N3,N3,N3′″, N3′″-tetra-p-tolyl-[1,1′:2′,1″:2″,1″-quarterphenyl]-3,3′″-diamine (BTPD), 4,4′-(diphenylsilanediyl)bis(N,N-di-p-tolylaniline) (DTASi), and 2,2-bis(4-carbazol-9-yl phenyl)adamantine (Ad-Cz); low molcular nitrogen containing compounds such as a hydrazone compound, a quinacridon compound, and a styrylamine compound; high molecular compounds such as polyaniline (PANT), a polyaniline-camphor sulfonic acid (PANI-CSA), 3,4-polyethylenedioxythiophene/polystyrene sulfonate (PEDOT/PSS), poly(triphenylamine) derivative (Poly-TPD), polyvinylcarbazole (PVCz), poly(p-phenylenevinylene)(PPV), and poly(p-naphthalenevinylene)(PNV); and aromatic hydrocarbon compounds such as 2-methyl-9,10-bis(naphthalene-2-yl) anthracene (MADN).

From the view point of effectively injecting and transporting holes from the anode, as the material of the hole injecting layer 146, it is preferable to use a material having a lower energy level of the highest occupied molecular orbit level (HOMO) than the material of the hole transporting layer 147. Further, as the material of the hole transporting layer 147, it is preferable to use a material having higher hole mobility than the materials of the hole injecting layer 146.

The hole injecting layer 146 and the hole transporting layer 147 may randomly include addition agents (a donor, an acceptor, or the like).

Then, in order to greater enhance the injecting property and the transporting property of the holes, it is preferable that the hole injecting layer 146 and the hole transporting layer 147 include acceptors. As the acceptor, it is possible to use acceptor materials according to the related art which is dedicated to the organic EL element. The specific compounds are exemplified below, but the present embodiment is not limited to the materials.

The acceptor may be any of the inorganic material or the organic material.

Examples of the inorganic material include gold (Au), platinum (Pt), tungsten (W), iridium (Ir), phosphorus oxychloride (POCl₃), ion hexafluoride arsenate (AsF₆—), chlorine (Cl), bromine (Br), iodine (I), vanadium oxide (V₂O₅), and molybdenum oxide (MoO₂).

Examples of the organic materials include compounds having a cyano group such as 7,7,8,8-tetracyanoquinodimethane (TCNQ), tetrafluorotetracyanoquinodimethan (TCNQF₄), tetracyanoethylene (TONE), hexacyanobutadiene (HCNB), and dicyclodicyanobenzoquinone (DDQ); compounds having a nitro group such as trinitrofluorenone (TNF) and dinitrofluorenone (DNF); fluorenyl; chloranil; and bromanil.

Among them, since the effect of increasing the hole concentration is higher, the compounds include a cyano group such as TCNQ, TCNQF₄, TONE, HCNB, and DDQ.

As the materials of the hole preventing layer 149, the electron transporting layer 150, and the electron injecting layer 151, materials according to the related art are used, and if the materials are the low molecular materials, examples of the materials of the hole preventing layer 149, the electron transporting layer 150, and the electron injecting layer 151 include inorganic materials which are the n-type semiconductor; oxadiazole derivatives such as 1,3-bis[2-(2,2′-bipyridine-6-yl)-1,3,4-oxadiazo-5-yl]benzene (Bpy-OXD), 1,3-bis(5-(4-(tert-butyl)phenyl)-1,3,4-oxadiazole-2-yl)benzene (OXD7); triazole derivatives such as 3-(4-biphenyl)-4-phenyl-5-tert-butylphenyl-1,2,4-triazole (TAZ); thiopyrazine dioxide derivatives; benzoquinone derivatives; naphthoquinone derivatives; anthraquinone derivatives; diphenoquinone derivatives; fluorenone derivatives; benzodifuran derivatives; quinoline derivatives such as 8-hydroxyquinolinolate-lithium (Liq); fluorene derivatives such as 2,7-bis[2-(2,2′-bipyridine-6-yl)-1,3,4-oxadiazo-5-yl]-9,9-dimethylfluorene (Bpy-FOXD); benzene derivatives such as 1,3,5-tri[(3-pyridyl)-pen-3-yl]benzene (TmPyPB) and 1,3,5-tri[(3-pyridyl)-pen-3-yl]benzene (TpPyPB); benzimidazole derivatives such as 2,2′,2″-(1,3,5-benzenetriyl)-tris(1-phenyl-1-H-benzimidazole (TPBI); pyridine derivatives such as 3,5-di(pyrene-1-yl)pyridine (PY1); biphenyl derivatives such as 3,3′,5,5′-tetra[(m-pyridyl)-pen-3-yl]biphenyl (BP4mPy); phenanthroline derivatives such as 4,7-diphenyl-1,10-phenanthroline (BPhen) and 2,9-dimethyl-4,7-diphenyl-1,10-phenanthroline (BCP); triphenyl borane derivatives such as tris(2,4,6-trimethyl-3-(pyridin-3-yl)phenyl)borane (3TPYMB); tetraphenylsilane derivatives such as diphenylbis(4-(pyridin-3-yl)phenyl)silane (DPPS); poly(oxadiazole) (Poly-OXZ), and polystyrene derivatives (PSS). In particular, examples of materials of an electron injecting layer 91 include fluoride such as fluorolithium (LiF) and fluorobarium (BaF₂); and oxides such as lithiumoxide (Li₂O).

From the view point of effectively injecting and transporting electrons from the cathode, as the materials of the electron injecting layer 151, it is preferable to use a material having a higher energy level of the lowest occupied molecular orbit level (LUMO) than the materials of the electron transporting layer 150. Further, as the material of the electron transporting layer 150, it is preferable to use a material having higher hole mobility than the materials of the electron injecting layer 151.

The electron transporting layer 150 and the electron injecting layer 151 may randomly include addition agents (a donor, an acceptor, or the like).

Then, in order to more enhance the injecting property and the transporting property of the holes, it is preferable that the electron transporting layer 150 and the electron injecting layer 151 include donors. As the donors, it is possible to use donor materials according to the related art which is dedicated to the organic EL element. The specific compounds are exemplified below, but the present embodiment is not limited to the materials.

The donor may be any of the inorganic material or the organic material.

Examples of the inorganic material include alkali metal such as lithium, sodium, and potassium; alkaline-earth metal such as magnesium and calcium; a rare-earth element; aluminum (Al); silver (Ag); copper (Cu); and iridium (In).

Examples of the organic materials include a compound having an aromatic tertiary amine skeleton, a polycyclic compound that may have a substituent group such as phenanthrene, pyrene, perylene, anthracene, tetracene, and pentacene, a tetrathiafulvalene (TTF) class, dibenzofuran, phenothiazine, and carbazole.

Examples of the compound having the aromatic tertiary amine skeleton include an aniline class; a phenylenediamine class; a benzidine class such as N,N,N′,N′-tetraphenylbenzidine, N,N′-bis-(3-methylphenyl)-N,N′-bis-(phenyl)-benzidine, N,N′-di(naphthalene-1-yl)-N,N′-diphenyl-benzidine; a triphenylamine class such as triphenylamine, 4,4′4″-tris(N,N-diphenyl-amino)-triphenylamine, 4,4′4″-tris(N-3-methylphenyl-N-phenyl-amino)-triphenylamine, and 4,4′4″-tris(N-(1-naphthyl)-N-phenyl-amino)-triphenylamine; and a triphenyldiamine class such as N,N′-di-(4-methyl-phenyl)-N,N′-diphenyl-1,4-phenylenediamine.

The description that a polycyclic compound “has a substituent group” refers to a case in which one or more hydrogen atoms in the polycyclic compound is substituted with a group other than the hydrogen atom (substituent group). The number of substituent groups is not especially limited, and all hydrogen atoms may be substituted with the substituent group. Then, the position of the substituent group is not especially limited.

Examples of the substituent groups include an alkyl group having 1-10 carbon atoms, an alkoxy group having 1-10 carbon atoms, an alkenyl group having 2-10 carbon atoms, an alkenyloxy group having 2-10 carbon atoms, an aryl group having 6-15 carbon atoms, an aryloxy group having 6-15 carbon atoms, a hydroxyl group, and an halogen atom.

The alkyl group may be any one of a straight chain shape, a branched chain shape, or a cyclic shape.

Examples of the straight chain-shaped or branched chain-shaped alkyl groups include a methyl group, an ethyl group, an n-propyl group, an isopropyl group, an n-butyl group, an isobutyl group, a sec-butyl group, a tert-butyl group, an n-pentyl group, an isopentyl group, a neopentyl group, a tert-pentyl group, a 1-methylbutyl group, an n-hexyl group, a 2-methylpentyl group, a 3-methylpentyl group, a 2,2-dimethylbutyl group, a 2,3-dimethylbutyl group, an n-heptyl group, a 2-methylhexyl group, a 3-methylhexyl group, a 2,2-dimethylpentyl group, a 2,3-dimethylpentyl group, a 2,4-dimethylpentyl group, a 3,3-dimethylpentyl group, a 3-ethylpentyl group, a 2,2,3-trimethylbutyl group, an n-octyl group, an isooctyl group, a nonyl group, and a decyl group.

The circular alkyl group may be any one of a monocyclic shape or a polycyclic shape, and examples of the circular alkyl group include a cyclopropyl group, a cyclobutyl group, a cyclopentyl group, a cyclohexyl group, a cycloheptyl group, a cyclooctyl group, a cyclononyl group, a cyclodecyl group, a norbonyl group, an isobornyl group, a 1-adamantyl group, a 2-adamantyl group, and a tricyclodecyl group.

Examples of the alkoxy group include a univalent group in which the alkyl group is coupled with an oxygen atom.

Examples of the alkenyl group includes an alkyl group having 2 to 10 carbon atoms in which one single bond (C—C) between carbon atoms is substituted with a double bond (C═C).

Examples of the alkenyloxy group include a univalent group in which the alkenyl group is coupled with an oxygen atom.

The aryl group may be any one of a monocyclic shape or a polycycilc shape, and the number of members is not especially limited. Examples of the aryl group preferably include a phenyl group, a 1-naphtyl group, and a 2-naphtyl group.

Examples of the aryloxy group include a univalent group in which the aryl group is coupled with the oxygen atom.

Examples of the halogen atom include a fluorine atom, a chlorine atom, a bromine atom, and an iodine atom.

Among these, a compound having an aromatic tertiary amine skeleton, a polycyclic compound that may have a substituent group, and alkali metal are preferable since an effect of increasing electron concentration is higher.

The organic light emitting layer 148 may be formed only of organic light emitting materials exemplified below, may be formed of the combination of the light emitting dopant and the host material, and may randomly include a hole transporting material, an electron transporting material, and an addition agent (a donor, an acceptor, or the like). Further, the organic light emitting layer 148 may have a configuration in which these respective materials are dispersed in the high molecular material (binder resin) or the inorganic material. From the view point of the light emission efficiency and the durability, it is preferable that the material of the organic light emitting layer 148 is a material in which the light emitting dopant is dispersed in the host material.

As the organic light emitting material, the light emitting material dedicated to the organic EL element according to the related art can be used.

Such light emitting material is classified into a low molecular light emitting material, a high molecular light emitting material, or the like. Specific compounds are exemplified below, but the present embodiment is not limited to these materials.

Examples of the low molcular light emitting material (including the host material) used in the organic light emitting layer 148 include an aromatic dimethylidene compound such as 4,4′-bis(2,2′-diphenylvinyl)-biphenyl (DPVBi); an oxadiazole compound such as 5-methyl-2-[2-[4-(5-methyl-2-benzoxazolyl)phenyl]vinyl]benzoxazole; a triazole derivative such as 3-(4-biphenyl)-4-phenyl-5-t-butylphenyl-1,2,4-triazole (TAZ); a styrylbenzene compound such as 1,4-bis(2-methylstyryl)benzene; an fluorescent organic material such as a thiopyrazine dioxide derivative, a benzoquinone derivative, a naphthoquinone derivative, an anthraquinone derivative, a diphenoquinone derivative, and a fluorenone derivative; a fluorescent light emitting organic metal complex such as an azo methine zinc complex, and a (8-hydroxyquinolinato)aluminum complex (Alq₃); BeBq (a bis(benzoquinolinolato)beryllium complex); 4,4′-bis-(2,2-di-p-tolyl-vinyl)-biphenyl (DTVBi); tris(1,3-diphenyl-1,3-propanedione)(monophenanthroline)Eu(III) (Eu(DBM)₃(Phen)); a diphenylethylene derivative; a triphenylamine derivative such as tris[4-(9-phenylfluoren-9-yl)phenyl]amine (TFTPA); a diaminocarbazole derivative; a bisstyryl derivative; an aromatic diamine derivative; a quinacridone-based compound; a perylene-based compound; a coumalin-based compound; a distyryl arylene derivative (DPVBi); an oligothiophene derivative (BMA-3T); a silane derivative such as 4,4′-di(triphenylsilyl)-biphenyl (BSB), diphenyl-di(o-tolyl)silane (UGH1), 1,4-bistriphenylsilyl benzene (UGH2), 1,3-bis(triphenylsilyl)benzene (UGH3), triphenyl-(4-(9-phenyl-9H-fluorene-9-yl)phenyl)silane (TPSi-F); a carbazole derivative such as 9,9-di(4-dicarbazole-benzyl)fluorene (CPF), 3,6-bis(triphenylsilyl)carbazole (mCP), 4,4′-bis(carbazole-9-yl)biphenyl (CBP), 4,4′-bis(carbazole-9-yl)-2,2′-dimethylbiphenyl (CDBP), N,N-dicarbazolyl-3,5-benzene(m-CP), 3-(diphenylphosphoryl)-9-phenyl-9H-carbazole (PPO1), 3,6-di(9-carbazolyl)-9-(2-ethylhexyl)carbazole (TCz1), 9,9′-(5-(triphenylsilyl)-1,3-phenylene)bis(9H-carbazole) (SimCP), bis(3,5-di(9H-carbazole-9-yl)phenyl)diphenylsilane (SimCP2), 3-(diphenylphosphoryl)-9-(4-diphenylphosphoryl)phenyl)-9H-carbazole (PPO21), 2,2-bis(4-carbazolylphenyl)-1,1-biphenyl (4CzPBP), 3,6-bis(diphenylphosphoryl)-9-phenyl-9H-carbazole (PPO2), 9-(4-tert-butylphenyl)-3,6-bis(triphenylsilyl)-9H-carbazole (CzSi), 3,6-bis[(3,5-diphenyl)phenyl]-9-phenyl-carbazole (CzTP), 9-(4-tert-butylphenyl)-3,6-ditrityl-9H-carbazole (CzC), 9-(4-tert-butylphenyl)-3,6-bis(9-(4-methoxyphenyl)-9H-fluorene-9-yl)-9H-carbazole (DFC), 2,2′-bis(4-carbazole-9-yl)phenyl)-biphenyl (BCBP), and 9,9′-((2,6-diphenylbenzo[1,2-b:4,5-b′]difuran-3,7-diyl)bis(4,1-phenylene))bis(9H-carbazole) (CZBDF); an aniline derivative such as 4-(diphenylphosphoryl)-N,N-diphenylaniline (HM-A1); a fluorene derivative such as 1,3-bis(9-phenyl-9H-fluorene-9-yl)benzene (mDPFB), 1,4-bis(9-phenyl-9H-fluorene-9-yl)benzene (pDPFB), 2,7-bis(carbazole-9-yl)-9,9-dimethylfluorene (DMFL-CBP), 2-[9,9-di(4-methylphenyl)-fluorene-2-yl]-9,9-di(4-methylphenyl)fluorene (BDAF), 2-(9,9-spirobifluorene-2-yl)-9,9-spirobifluorene (BSBF), 9,9-bis[4-(pyrenyl)phenyl]-9H-fluorene (BPPF), 2,2′-dipyrenyl-9,9-spirobifluorene (Spiro-Pye), 2,7-dipyrenyl-9,9-spirobifluorene(2,2′-Spiro-Pye), 2,7-bis[9,9-di(4-methylphenyl)-fluorene-2-yl]-9,9-di(4-methylphenyl)fluorene (TDAF), 2,7-bis(9,9-spirobifluorene-2-yl)-9,9-spirobifluorene (TSBF), and 9,9-spirobifluorene-2-yl-diphenyl-phosphine oxide (SPPO1); a pyrene derivative such as 1,3-di(pyrene-1-yl)benzene (m-Bpye); a benzoate derivative such as propane-2,2′-diylbis(4,1-phenylene)dibenzoate (MMA1); a phosphine oxide derivative such as 4,4′-bis(diphenylphosphine oxide)biphenyl (PO1), and 2,8-bis(diphenylphosphoryl)dibenzo[b,d]thiophene (PPT); a terphenyl derivative such as 4,4″-di(triphenylsilyl)-p-terphenyl (BST); and a triazine derivative such as 2,4-bis(phenoxy)-6-(3-methyldiphenylamino)-1,3,5-triazine (BPMT).

Examples of the high molecular light emitting materials used in the organic light emitting layer 148 include a polyphenylene vinylene derivative such as poly(2-decyloxy-1,4-phenylene) (DO-PPP), poly[2,5-bis-[2-(N,N,N-triethylammonium) ethoxy]-1,4-phenyl-alto-1,4-phenylene]dibromide (PPP-NEt³⁺), poly[2-(2′-ethylhexyloxy)-5-methoxy-1,4-phenylenevinylene] (MEH-PPV), poly[5-methoxy-(2-propanoxypropanoxysulfonide)-1,4-phenylenevinylene] (MPS-PPV), and poly[2,5-bis-(hexyloxy)-1,4-phenylene-(1-cyanovinylene)] (CN-PPV); a polyspiro derivative such as poly(9,9-dioctylfluorene) (PDAF); and a carbazole derivative such as poly(N-vinylcarbazole) (PVK).

The low molecular light emitting material is preferable as the organic light emitting material. From the view point of low power consumption, it is preferable to use the phosphorescent material having high light emission efficiency.

The dopants for the organic EL element according to the related art can be used as the light emitting dopant used in the organic light emitting layer 148. If the dopants are ultraviolet light emitting materials, examples of the light emitting dopants include fluorescent light emitting materials such as p-quarterphenyl, 3,5,3,5-tetra-tert-butylsexyphenyl, and 3,5,3,5-tetra-tert-butyl-p-quinquephenyl. Further, if the light emitting dopants are blue light emitting materials, examples of the light emitting dopants include a fluorescent light emitting material such as a styryl derivative; and a phosphorescent phosphorescent light emitting organic metal complex such as bis[(4,6-difluorophenyl)-pyridinato-N,C2′]picolinate iridium(III) (FIrpic), and bis(4′,6′-difluorophenylpyridinato)tetrakis(1-pyrazolyl)borate iridium(III) (FIr6). Further, if the light emitting dopants are green light emitting materials, examples of the light emitting dopants include a phosphorescent light emitting organic metal complex such as tris(2-phenylpyridinato)iridium (Ir(ppy)₃).

In addition, the materials of the respective layers configuring the organic EL layer 144 are described. However, for example, the host materials can be used as the hole transporting materials or the electron transporting materials, and the hole transporting materials and the electron transporting materials can also be used as the host materials.

The wet processes, the dry processes, the laser transferring method, and the like according to the related art are used as the forming methods of the respective layers of the hole injecting layer 146, the hole transporting layer 147, the organic light emitting layer 148, the hole preventing layer 149, the electron transporting layer 150, and the electron injecting layer 151.

Examples of the wet processes include a coating method such as the spin coating method, the dipping method, the doctor blade method, the discharge coating method, and the spray coating method; and a printing method such as an ink-jet method, a letter press printing method, an intaglio printing method, a screen printing method, and a microgravure coating method, by using liquid obtained by dissolving and dispersing the materials that configure the respective layers in a solvent.

The liquid used in the coating method or the printing method may include an addition agent for adjusting a physical property of the liquid, such as a leveling agent and a viscosity adjusting agent.

As the dry processes, a resistance heating vapor deposition method, an electron beam (EB) deposition method, a molecular beam epitaxy (MBE) method, a sputtering method, an organic vapor phase deposition (OVPD) method, and the like that use the materials configuring the respective layers are used.

The thicknesses of the respective layers of the hole injecting layer 146, the hole transporting layer 147, the organic light emitting layer 148, the hole preventing layer 149, the electron transporting layer 150, and the electron injecting layer 151 generally range from 1 nm to 1,000 nm, and preferably range from 10 nm to 200 nm. If the film thickness is less than 10 nm, physical properties (an injecting property, a transporting property, and a confinement property) required in the related art are not obtained. Further, there is a concern that the pixel defect may be caused by foreign substances such as dirt. Meanwhile, if the film thickness exceeds 200 nm, the drive voltage increases from resistance components of the organic EL layer 144. As a result, the power consumption increases.

The edge cover 152 can be formed by the methods according to the related art such as the EB deposition method, the sputtering method, the ion plating method, and the resistance heating vapor deposition method, by using insulating materials, and can be patterned by the photolithographic method of the dry method or the wet method according to the related art, but the present embodiment is not limited to the materials and the forming methods.

Further, materials according to the related art are used as the insulating materials configuring the edge cover 152, but the present embodiment is not especially limited to the insulating materials.

Since the edge cover 152 needs to transmit light, examples of the insulating materials configuring the edge cover 152 include SiO, SiON, SiN, SiOC, SiC, HfSiON, ZrO, HfO, and LaO.

It is preferable that the film thickness of the edge cover 152 ranges from 100 nm to 2,000 nm. If the film thickness is less than 100 nm, the insulating property is not sufficient, and the leakage occurs between the first electrode 143 and the second electrode 145, causing the increase of the power consumption and the light emission failure. Meanwhile, if the film thickness exceeds 2,000 nm, the film forming process requires a longer time causing the decrease of the production efficiency and the disconnection of the second electrode 145 by the edge cover 152.

Here, it is preferable that the organic EL element 142 has the microcavity structure (optical microresonator structure) by the interference effect between the first electrode 143 and the second electrode 145 or the microcavity structure (optical microresonator structure) by the dielectric multilayered film. If the microresonator structure is formed by the first electrode 143 and the second electrode 145, it is possible to concentrate the emission light of the organic EL layer 144 in the front surface direction (light ejecting direction) by the interference effect between the first electrode 143 and the second electrode 145. At this point, since it is possible to cause the emission light of the organic EL layer 144 to have directivity, it is possible to reduce the loss of the emission light escaping to the circumference and to increase the light emission efficiency. Accordingly, it is possible to effectively convey the energy of the emission light generated in the organic EL layer 144 to the phosphor layer and to increase the brightness of the front surface of the display device.

Further, the light emission spectrum of the organic EL layer 144 can be adjusted by the interference effect between the first electrode 143 and the second electrode 145 and thus can be adjusted to the desired emission light peak and the half value width. Accordingly, the spectrum of the organic EL layer 144 can be adjusted to be the spectrum that can effectively excite the red phosphor and the green phosphor so that the color purity of the blue pixel can be increased.

Further, the display device according to the present embodiment is electrically connected to the external drive circuit (scanning line electrode circuit, data signal electrode circuit, and electric power circuit).

Here, as the substrate 141 configuring the organic EL element substrate 140, a substrate obtained by coating an insulating material on a glass substrate may be used, a substrate obtained by coating an insulating material on a metal substrate or a plastic substrate is preferably used, and a substrate obtained by coating an insulating material on a metal substrate or a plastic substrate is more preferably used.

### (LED)

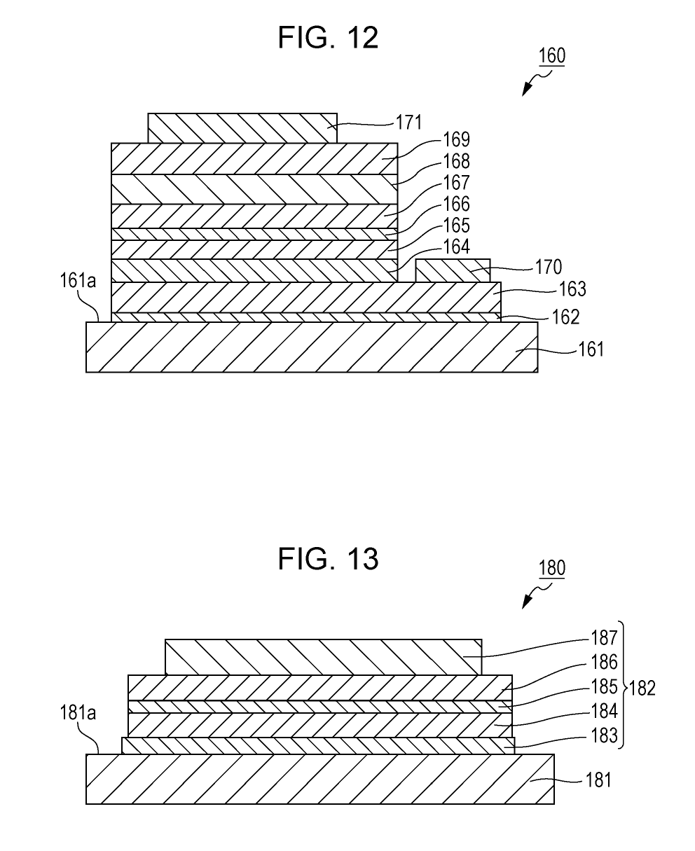

FIG. 12 is a schematic cross-sectional view illustrating an LED substrate that configures the light source 110 according to an embodiment.

An LED substrate 160 is mainly formed of a substrate 161, a first buffer layer 162, an n-type contact layer 163, a second n-type clad layer 164, a first n-type clad layer 165, an active layer 166, a first p-type clad layer 167, a second p-type clad layer 168, and a second buffer layer 169 which are sequentially stacked on one surface 161a of the substrate 161, a cathode 170 formed on the n-type contact layer 163, and an anode 171 formed on the second buffer layer 169.

In addition, other LEDs according to the related art, for example, an ultraviolet light emitting inorganic LED and a blue light emitting inorganic LED, can be used as the LED, but the specific configuration is not limited to the above.

Here, respective configuration elements of the LED substrate 160 are described in detail.

The active layer 166 is a layer that emits light by the recombination of electrons and holes, and active layer materials for an LED according to the related art can be used as the active layer material. Examples of the active layer materials include AlGaN, InAlN, and InₐAl_{b}Ga_{1-a-b}N (0≦a, 0≦b, a+b≦1) as ultraviolet active layer materials, and include In_{z}Ga_{1-z}N (0<z<1) as blue active layer materials, but the present embodiment is not limited thereto.

Further, a single quantum well structure or a multiple quantum well structure is used as the active layer 166. The active layer of the quantum well structure may be any of an n type or a p type. In particular, if a non-doped (no-impurity added) active layer is used, the half value width of the emission light wavelength becomes narrow by the light emission between bands, so the emission light having better color purity can be obtained. Therefore, the non-doped active layer is preferable.

Further, at least one of the donor impurity or the acceptor impurity may be doped on the active layer 166. If the crystalizability of the impurity-doped active layer is equal to that of the non-doped active layer, the light emission strength between bands can be stronger by doping the donor impurities, compared to that of the non-doped active layer. If the acceptor impurity is doped, the peak wavelength can be shifted to the low energy side by approximately 0.5 eV from the peak wavelength of the emission light between bands, but the half value width becomes wider. If both of the acceptor impurities and the donor impurities are doped, it is possible to cause the light emission strength to become even stronger than the light emission strength of the active layer in which only the acceptor impurities are doped. In particular, if the active layer in which the acceptor impurities are doped is formed, it is preferable to cause the conductivity type of the active layer to be an n type by doping the donor impurities such as Si.

N-type clad layer materials for an LED according to the related art can be used as the second n-type clad layer 164 and the first n-type clad layer 165, and the second n-type clad layer 164 and the first n-type clad layer 165 can be a single layer configuration or a multilayered configuration. If the second n-type clad layer 164 and the first n-type clad layer 165 are formed of an n-type semiconductor having a greater band distance energy than the active layer 166, a potential barrier against holes is formed between the second n-type clad layer 164, the first n-type clad layer 165, and the active layer 166. Therefore, it is possible to confine the holes in the active layer 166. For example, it is possible to form the second n-type clad layer 164 and the first n-type clad layer 165 by n-type InₓGa₁₋ₓN (0≦x<1), but the present embodiment is not limited thereto.

P-type clad layer materials for an LED according to the related art can be used as the first p-type clad layer 167 and the second p-type clad layer 168, and the first p-type clad layer 167 and the second p-type clad layer 168 may be a single layer configuration or a multilayered configuration. If the first p-type clad layer 167 and the second p-type clad layer 168 are formed of the p-type semiconductor having a greater band distance energy than the active layer 166, a potential barrier against electrons is formed between the first p-type clad layer 167 and the second p-type clad layer 168, and the active layer 166. Therefore, it is possible to confine the electrons in the active layer 166. For example, it is possible to form the first p-type clad layer 167 and the second p-type clad layer 168 by Al_{y}Ga_{1-y}N (0≦y≦1), but the present embodiment is not limited thereto.

Contact layer materials for an LED according to the related art can be used as the n-type contact layer 163. For example, the n-type contact layer 163 made of n-type GaN can be formed as a layer that is in contact with the second n-type clad layer 164 and the first n-type clad layer 165 and forms electrodes. Further, a p-type contact layer made of p-type GaN can be formed as a layer that is in contact with the first p-type clad layer 167 and the second p-type clad layer 168 and forms electrodes. However, if the second n-type clad layer 164 and the second p-type clad layer 168 are made of GaN, the p-type contact layer does not need to be especially formed and the second clad layers (the second n-type clad layer 164 and the second p-type clad layer 168) can be used as contact layers.

Film forming processes for an LED according to the related art can be used as the forming methods of the respective layers used in the present embodiment, but the present embodiment is not especially limited thereto. For example, the respective layers can be formed on a substrate of sapphire (including the C surface, the A surface, and the R surface), SiC (including 6H-SiC and 4H-SiC), spinel (MgAl₂O₄, especially the (111) surface thereof), ZnO, Si, or GaAs, or other oxide single crystal substrates (NGO or the like) by using vapor phase epitaxy methods such as a metal organic vapor phase epitaxy method (MOVPE), a molcular beam vapor phase epitaxy method (MBE), and a hydride vapor phase epitaxy method (HDVPE).

### (Inorganic EL Element)

FIG. 13 is a schematic cross-sectional view illustrating an inorganic EL element substrate (light source) that configures the display device according to an embodiment.

An inorganic EL element substrate 180 is mainly formed of a substrate 181 and an inorganic EL element 182 provided on one surface 181a of the substrate 181.

The inorganic EL element 182 is formed of a first electrode 183, a first dielectric layer 184, a light emitting layer 185, a second dielectric layer 186, and a second electrode 187, which are sequentially stacked on the one surface 181a of the substrate 181.

The first electrode 183 and the second electrode 187 function as the anode or the cathode of the inorganic EL element 182, in pairs.

In addition, inorganic EL elements according to the related art, for example, the inorganic ultraviolet light emitting EL element and the inorganic blue light emitting EL element, can be used as the inorganic EL element 182, but the specific configuration is not limited thereto.

Hereinafter, the constituent members configuring the inorganic EL element substrate 180 and the forming methods thereof are specifically described, but the present embodiment is not limited to the materials and the forming methods.

A substrate which is the same as the substrate 161 configuring the organic EL element substrate 160 is used as the substrate 181.

The first electrode 183 and the second electrode 187 function as the anode or the cathode of the inorganic EL element 182 in pairs. That is, when the first electrode 183 is set to be the anode, the second electrode 187 becomes the cathode, and when the first electrode 183 is set to be the cathode, the second electrode 187 becomes the anode.

In the first electrode 183 and the second electrode 187, examples of the transparent electrode materials include metal such as aluminum (Al), gold (Au), platinum (Pt), and nickel (Ni), and oxides such as an oxide (ITO) made of iridium (In) and tin (Sn), an oxide (SnO₂) made of tin (Sn), and an oxide (IZO) made of iridium (In) and zinc (Zn), but the present embodiment is not limited to the materials. The electrodes on the side of ejecting the light may be transparent electrodes such as ITO, and it is preferable to use reflective electrodes made of aluminum or the like in the electrode on the opposite side in the direction of ejecting the light.

The first electrode 183 and the second electrode 187 can be formed by the methods according to the related art such as the EB deposition method, the sputtering method, the ion plating method, and the resistance heating vapor deposition method, but the present embodiment is not limited to the materials and the forming methods. Further, the electrodes formed by the photolithographic method, and the laser peeling method can be patterned, if necessary, and the electrode directly patterned can be formed by combining with the shadow mask.

It is preferable that the film thicknesses of the first electrode 183 and the second electrode 187 are equal to or greater than 50 nm.

If the film thickness is less than 50 nm, there is a concern that the wiring resistance increases and the drive voltage increases.

Dielectric materials for an inorganic EL element according to the related art can be used as the first dielectric layer 184 and the second dielectric layer 186. Examples of the dielectric materials include tantalum pentoxide (Ta₂O₅), silicon oxide (SiO₂), silicon nitride (Si₃N₄), aluminum oxide (Al₂O₃), aluminum titanate (AlTiO₃), barium titanate (BaTiO₃), and strontium titanate (SrTiO₃), but the present embodiment is not limited to the dielectric materials.

Further, the first dielectric layer 184 and the second dielectric layer 186 may have the single layer structure made of one selected from the dielectric materials, or may have the multilayered structure obtained by stacking two or more materials.

Further, it is preferable that the film thicknesses of the first dielectric layer 184 and the second dielectric layer 186 range from 200 nm to 500 nm.

Light emitting materials for an inorganic EL element according to the related art can be used as the light emitting layer 185. Examples of the light emitting materials include ZnF₂:Gd as the ultraviolet light emitting material, and include BaAl₂S₄:Eu, CaAl₂S₄:Eu, ZnAl₂S₄:Eu, Ba₂SiS₄:Ce, ZnS:Tm, SrS:Ce, SrS:Cu, CaS:Pb, and (Ba,Mg)Al₂S₄:Eu as the blue light emitting material, but the present embodiment is not limited to the light emitting materials.

Further, it is preferable that the film thickness of the light emitting layer 185 range from 300 nm to 1,000 nm.

In addition, when an organic EL element substrate, an LED substrate, an inorganic EL element substrate, or the like is used as the light source 110, it is preferable to prepare a sealing film or a sealing substrate that seals the emission light elements such as the organic EL element, the LED, and the inorganic EL element. The sealing film and the sealing substrate can be formed by the sealing materials and the sealing methods according to the related art. Specifically, the sealing film can be formed by coating the resin on the surface on the opposite side to the substrate configuring the light source by using the spin coat method, the ODF, the lamirate method, or the like. Otherwise, after the inorganic film such as SiO, SiON, SiN is formed by the plasma CVD method, the ion plating method, the ion beam method, the sputtering method, and the like, the sealing film is further formed by coating the resin by using the spin coat method, the ODF, the lamirate method, or the like or the sealing substrate may be bonded together.

It is possible to prevent the contamination of oxygen or moisture from the outside to the emission light element by the sealing film or the sealing substrate, so that the life span of the light source increases.

According to the display device according to the present embodiment, while the opening ratio of the fluorescent substrate is set to be wide, since the influence of the color fading is suppressed to be small, the color reproduction range is wide, and the display device having high efficiency in the ejecting light can be realized. Further, since a microlens is not used, while less members for configuring the display device are provided, the display device having high efficiency and high color reproduction property can be realized.

### [Electronic Apparatus]

The display device can be applied to various electronic apparatuses.

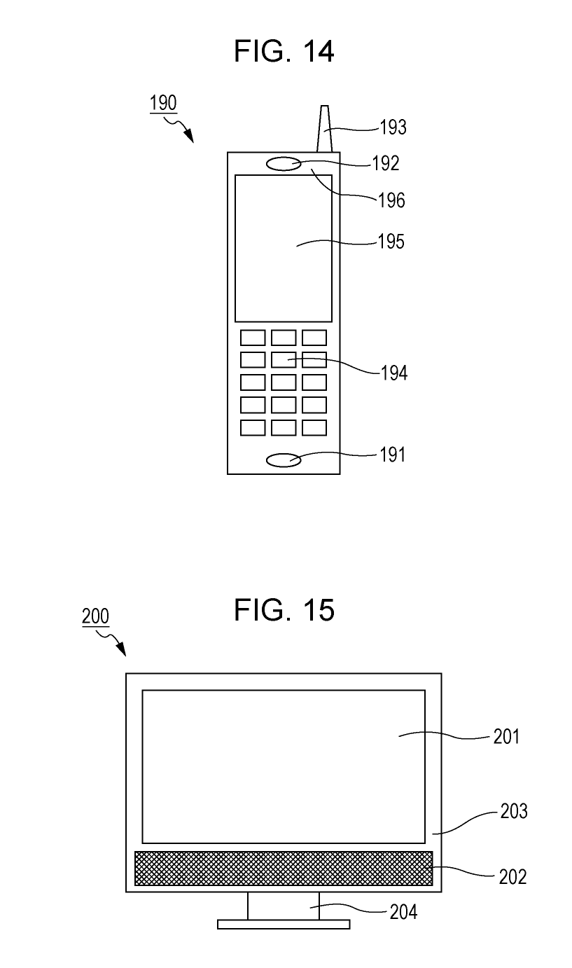

Hereinafter, the electronic apparatus including the display device is described with reference to FIGS. 14 to 18.

The display device can be applied to, for example, a cellular phone illustrated in FIG. 14.

A cellular phone 190 illustrated in FIG. 14 includes an sound input portion 191, a sound output portion 192, an antenna 193, an operating switch 194, a display portion 195, a housing 196, or the like.

Then, the display device can be applied as the display portion 195. A video can be displayed in good light emission efficiency by applying the display device to the display portion 195 of the cellular phone 190.

Further, the display device can be applied to, for example, the thin-type television illustrated in FIG. 15.

A thin-type television 200 illustrated in FIG. 15 includes a display portion 201, a speaker 202, a cabinet 203, a stand 204, and the like.

Then, the display device can be appropriately applied as the display portion 201. A video can be displayed in good light emission efficiency by applying the display device to the display portion 201 of the thin-type television 200.

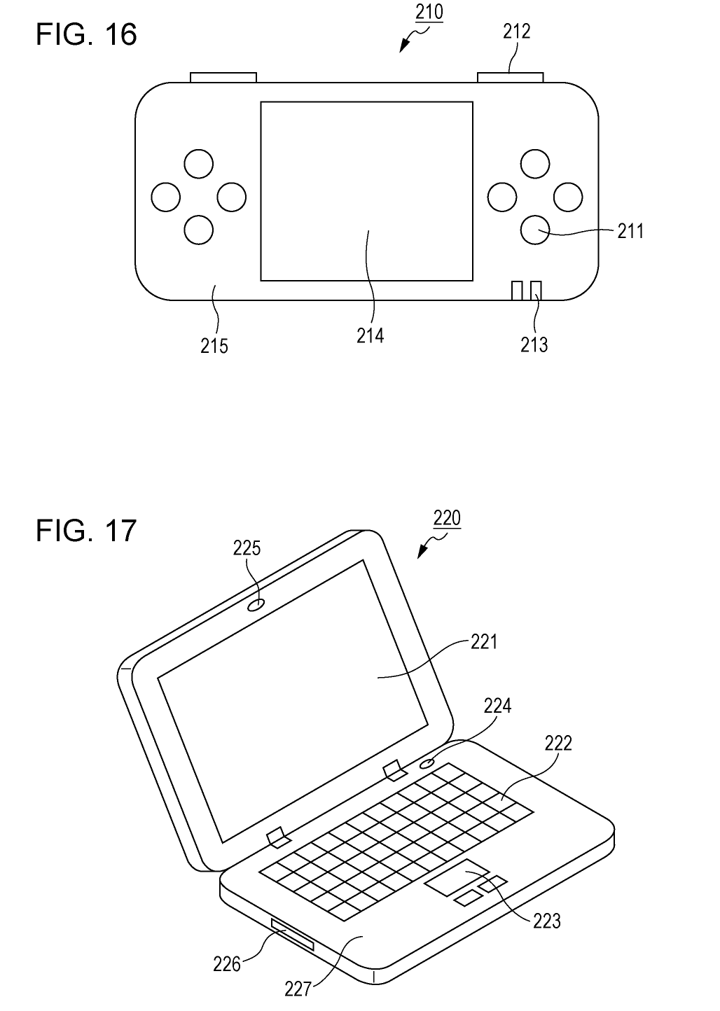

Further, the display device can be applied to, for example, a portable game machine illustrated in FIG. 16.

A portable game machine 210 illustrated in FIG. 16 includes operator buttons 211 and 212, an external connecting terminal 213, a display portion 214, a housing 215, and the like.

Then, the display device can be appropriately applied as the display portion 214. A video can be displayed in good light emission efficiency by applying the display device to the display portion 214 of the portable game machine 210.

Further, the display device can be applied to, for example, a notebook computer illustrated in FIG. 17.

A notebook computer 220 illustrated in FIG. 17 includes a display portion 221, a keyboard 222, a touchpad 223, a main switch 224, a camera 225, a recording medium slot 226, a housing 227, and the like.

Then, the display device can be appropriately applied as the display portion 221. A video can be displayed in good light emission efficiency by applying the display device to the display portion 221 of the notebook computer 220.

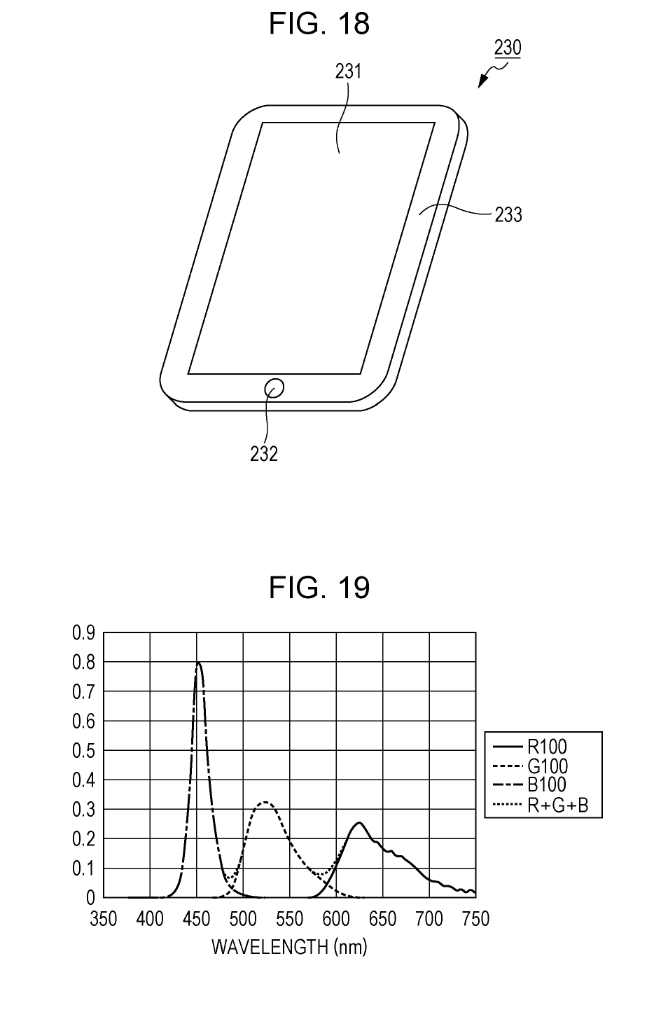

Further, the display device can be applied to, for example, a tablet terminal illustrated in FIG. 18.

A tablet terminal 230 illustrated in FIG. 18 includes a display portion (touch panel) 231, a camera 232, a housing 233, and the like.

Then, the display device can be appropriately applied as the display portion 231. A video can be displayed in good light emission efficiency by applying the display device to the display portion 231 of the tablet terminal 230.

In the above, appropriate embodiments according to the invention are described with reference to the drawings, but it is obvious that the invention is not limited to the embodiments. The entirety of shapes or the combinations of the respective constituent members described according to the embodiments are provided as examples, and can be variously changed based on requirements of design without departing from the main idea of the invention.

In addition, detailed descriptions relating to shapes, the number, arrangement, materials, forming methods, or the like of the respective configuration elements of the display device are not limited to the embodiments, and can be changed appropriately.

### EXAMPLES

Hereinafter, the invention is described in greater detail by examples and comparative examples, but the invention is not limited to the embodiments described below.

### Example 1

The effect of the fluorescent substrate illustrated in FIG. 1 is verified.

In the verification, as illustrated in FIG. 1, the red sub-pixel 12R, the blue sub-pixel 12B, and the green sub-pixel 12G in one of the pixels 12 were provided in parallel, and the distance d₁ between the red sub-pixel 12R and the blue sub-pixel 12B, the distance d₂ between the blue sub-pixel 12B and the green sub-pixel 12G, and the distance d₃ between the green sub-pixel 12G and the red sub-pixel 12R were set to satisfy the relationship of d₁>d₂>d₃.

Further, the sub-pixels for respective colors were formed in the size of 100 μm×300 μm. Further, the center of the blue sub-pixel 12B was formed to approach the green sub-pixel 12G (another pixel which was not the red sub-pixel 12R), and also the center of the red sub-pixel 12R was formed to approach the green sub-pixel 12G (another pixel which was not the blue sub-pixel 12B).

In addition, a red phosphor having a maximum absorption wavelength Rλmax of 625 nm was used as the material of the red phosphor layer 14 configuring the red sub-pixel 12R.

The display device according to Example 1 was prepared by stacking the fluorescent substrate 10 according to Example 1 and the light source having directivity of emitting the excitation light radiating each of the pixels 12 of the fluorescent substrate 10 with the excitation light amount modulation layer with the liquid crystal element interposed therebetween.

With respect to the display device, the light emission spectrums of the red sub-pixel 12R, the blue sub-pixel 12B, and the green sub-pixel 12G were measured. The results thereof are illustrated in FIG. 19.

In FIG. 19, the spectrum of the red light and the spectrum of the green light are spectrums obtained after the light emission spectrums of the respective sub-pixels passed through color filters. Further, the spectrum of the blue light is a spectrum obtained after the excitation light from the light source passed through the color filter. The strengths of the emission light from the respective sub-pixels were adjusted so as to display a white color of 12,000 K when the strengths were added respectively at the opening ratios of the respective sub-pixels. Hereinafter, the spectrums of the respective colors were set to be 100 to perform trial calculation on the color fading.

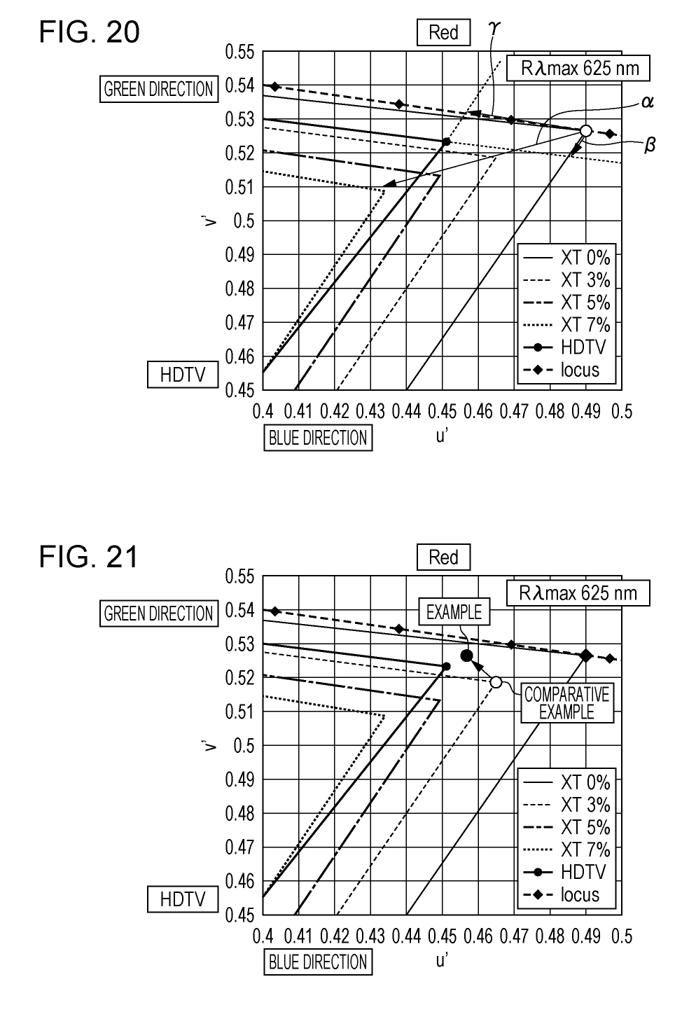

Further, a partially expanded diagram illustrating a chromaticity coordinate diagram indicating the color reproduction range of the display device having spectrums of three primary colors as illustrated in FIG. 19 is illustrated in FIG. 20.

“O” indicating the coordinates on the upper right of FIG. 20 is chromaticity coordinates of the spectrums of the red light from the display device in Example 1, and originally the display device of Example 1 was to display red indicated by the coordinates.

### Comparative Example 1

The red sub-pixel, the blue sub-pixel, and the green sub-pixel in one pixel were provided in parallel, the display device according to Comparative Example 1 were prepared in the same manner as in Example 1 except that the fluorescent substrate in which the distance d₁ between the red sub-pixel and the blue sub-pixel, the distance d₂ between the blue sub-pixel and the green sub-pixel, and the distance d₃ between the green sub-pixel and the red sub-pixel satisfied the relationship of d₁=d₂=d₃ was used.

In the display device of Comparative Example 1, when the excitation light amount modulation layer (liquid crystal layer) corresponding to the red sub-pixel was turned ON and the excitation light amount modulation layers (liquid crystal layers) corresponding to the blue sub-pixel and the green sub-pixel were turned OFF, red of the coordinates illustrated in FIG. 20 was not displayed, and faint red was displayed.

This was because the excitation light that passed through the excitation light amount modulation layer corresponding to the red sub-pixel was incident on the green phosphor of the green sub-pixel and the phosphor of the blue sub-pixel to cause the red display to be faint.

In Comparative Example 1, since the red sub-pixel, the blue sub-pixel, and the green sub-pixel were provided at the same interval, red become fainter at the same ratio in the green direction and the blue direction (an arrow a of FIG. 20). As a result, with excitation light at 1.5% for each unit, 3% in total was incident on an adjacent pixel as crosstalk (XT), the red display became faint and the red display to HDTV standard was not able to be performed.

This was because the allowed amount of the red display in Comparative Example 1 was small in the direction of causing the red display to become faint in the blue direction. In order to display a color to HDTV standards, and display bright red, prevention of red from becoming faint in the blue direction (an arrow β in FIG. 20) was required. Meanwhile, the amount of red that became faint in the green direction had a margin greater than the amount of red that become faint in the blue direction (an arrow y in FIG. 20).

In contrast, in Example 1, in order to prevent the blue crosstalk from being mixed with the red display to cause the red display to become faint in the blue direction, the position of the red sub-pixel 12R was caused to be deviated by 10 μm to approach the green sub-pixel 12G compared with Comparative Example 1, so that the distance d₁ between the red sub-pixel 12R and the blue sub-pixel 12B become greater than the other distances of the distance d₂ between the blue sub-pixel 12B and the green sub-pixel 12G and the distance d₃ between the green sub-pixel 12G and the red sub-pixel 12R (d₁>d₂>d₃). As a result, the amount of the blue crosstalk that was mixed with the red display was able to be reduced so that blueness of the red display was improved and red to HDTV standards was able to be displayed (FIG. 21).

Further, referring to the chromaticity coordinate diagram illustrated in FIG. 21, it is assumed that the crosstalk amount toward red was green 1.5%/blue 1.5% (3% in total) in Comparative Example 1, but was approximately green 2.5%/blue 0.7% (3.2% in total) in Example 1.

### Example 2

The fluorescent substrate of Example 2 was prepared in the same manner as in Example 1 except that the red phosphor having the maximum absorption wavelength Rλmax of 640 nm was used as material of the red phosphor layer 14 configuring the red sub-pixel 12R, and the display device of Example 2 was prepared in the same manner as in Example 1 by using the fluorescent substrate.

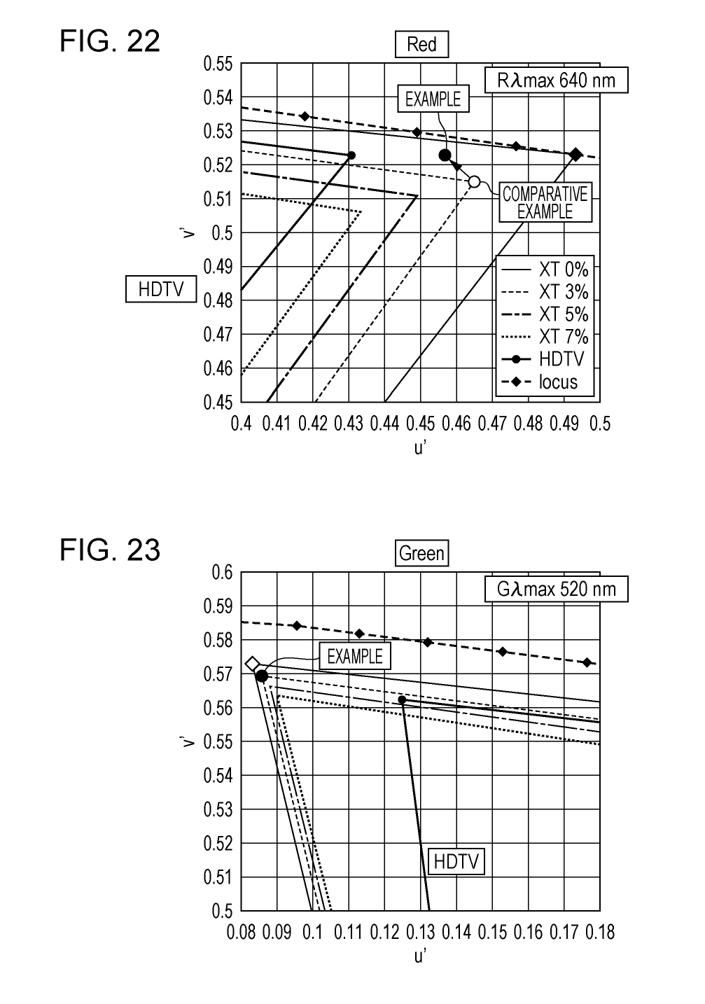

With respect to the display device, the light emission spectrums of the red sub-pixel 12R, the blue sub-pixel 12B, and the green sub-pixel 12G were measured. A partially expanded chromaticity coordinate diagram illustrating the color reproduction range of the display device having spectrums of three primary colors is illustrated in FIG. 22.

### Comparative Example 2

The red sub-pixel, the blue sub-pixel, and the green sub-pixel in one pixel were provided in parallel, the display device according to Comparative Example 2 were prepared in the same manner as in Example 2 except that the fluorescent substrate in which the distance d₁ between the red sub-pixel and the blue sub-pixel, the distance d₂ between the blue sub-pixel and the green sub-pixel, and the distance d₃ between the green sub-pixel and the red sub-pixel satisfying the relationship of d₁=d₂=d₃ was used.

In Comparative Example 2, since the red sub-pixel, the blue sub-pixel, and the green sub-pixel were provided at the same interval, red became fainter at the same ratio in the green direction and the blue direction. As a result, with excitation light at 1.5% for each unit, 3% in total was incident on an adjacent pixel as crosstalk, the red display became faint, and the red display to HDTV standards was not able to be performed.

In contrast, in Example 2, the amount of mixing the blue crosstalk with the red display was able to be reduced, so that blueness of the red display was improved and red in the standard was able to be displayed, and at the same time, it was possible to display bright red close to a spectrum locus.

Further, referring to the chromaticity coordinate diagram illustrated in FIG. 22, it is assumed that the crosstalk amount toward red was green 1.5%/blue 1.5% (3% in total) in Comparative Example 2, but was approximately green 2.5%/blue 0.7% (3.2% in total) in Example 2.

### Example 3

The fluorescent substrate of Example 3 was prepared in the same manner as in Example 1 except that the red phosphor having the maximum absorption wavelength Rλmax of 520 nm was used as materials of the red phosphor layer 14 configuring the red sub-pixel 12R, and the distance between the green sub-pixel 12G and the blue sub-pixel 12B was caused to be greater instead of causing the distance between the red sub-pixel 12R and the blue sub-pixel 12B to be greater and the display device of Example 3 was prepared in the same manner as in Example 1 by using the fluorescent substrate. In the display device, with respect to the present embodiment, an influence of narrowing the distance between the blue sub-pixel and the green sub-pixel was checked.

With respect to the display device, the light emission spectrum of the red sub-pixel 12R, the blue sub-pixel 12B, and the green sub-pixel 12G was measured. A chromaticity coordinate diagram of CIE 1976 UCS (u′, v′) which indicates the color reproduction range of the display device having spectrums of three primary colors and in which the green area was expanded is illustrated in FIG. 23.

Even if the adjacent pixel crosstalk was mixed with the green display, the color fading was smaller than in the case of red display. With excitation light at 1.5% for each unit, 3% in total was incident on an adjacent pixel as crosstalk, the chromacity change Δu′v′ (defined as Δu′v′=((u′−u₀)²+(v′−v₀)²)^{0.5}) between a color displayed by a pure spectrum of the phosphor and a color generated from the pixel of the display device was 0.028 in the case of the red display, but 0.003 in the case of the green display, which was 1/10 of the red display. In Example 3, the brightness of green was not lost to a visibly recognizable degree and the color did not become faint so that green to HDTV standards was not displayed.

Accordingly, the allowed amount of the contamination of the green display to the blue crosstalk is greater than that in the red display.

In the fluorescent substrate according to the invention, it is preferable that a red phosphor layer that emits red light from excitation light incident from an excitation light source is provided in the red sub-pixel, a blue phosphor layer that emits blue light from the excitation light is provided in the blue sub-pixel, and a third color phosphor layer that emits third color light from the excitation light is provided in the third color sub-pixel.

In the fluorescent substrate according to the invention, it is preferable that the red phosphor layer that emits red light from the excitation light incident from the excitation light source is provided in the red sub-pixel, the light scattering layer that scatters the excitation light is provided in the blue sub-pixel, and the third color phosphor layer that emits third color light from the excitation light is provided in the third color sub-pixel.

In the fluorescent substrate according to the invention, it is preferable that the third color is green.

In the fluorescent substrate according to the invention, the pixel further includes a fourth color sub-pixel that performs display of fourth color light which is the same as or different from the red light, the blue light, or the green light, and the red sub-pixel and the blue sub-pixel are provided so that respective long sides are separate from each other.

In the fluorescent substrate according to the invention, it is preferable that a fourth color phosphor layer that emits a fourth color from the excitation light is provided in the fourth color sub-pixel.

In the fluorescent substrate according to the invention, it is preferable that, when a main wavelength of the red light displayed by the red sub-pixel is λᵣ, a main wavelength of the blue light displayed by the blue sub-pixel is λ_{b}, and a main wavelength of the fourth color light displayed by the fourth color sub-pixel is λ₄, a relationship of λ_{b}<λ₄<λᵣ is satisfied.

In the fluorescent substrate according to the invention, it is preferable that when a main wavelength of the red light displayed by the red sub-pixel is λᵣ, a main wavelength of the green light displayed by the green sub-pixel is λ_{g}, and a main wavelength of the fourth color light displayed by the fourth color sub-pixel is λ₄, a relationship of λ_{g}<λ₄<λᵣ is satisfied.

In the fluorescent substrate according to the invention, when a main wavelength of the green light displayed by the green sub-pixel is λ_{g}, and a main wavelength of the fourth color light displayed by the fourth color sub-pixel is λ₄, a relationship of λ₄=λ_{g} is satisfied.

The display device according to the invention includes the fluorescent substrate according to the invention, a light source having directivity that emits excitation light radiated on the pixel, and an excitation light amount modulation layer that overlaps the fluorescent substrate and adjusts a light amount of the excitation light incident on the pixel of the fluorescent substrate.

In the display device according to the invention, it is preferable that a pixel opening portion of a phosphor in the fluorescent substrate and a pixel opening portion of the excitation light amount modulation layer are formed so that positions thereof substantially coincide.

In the display device according to the invention, it is preferable that the excitation light amount modulation layer is formed of a liquid crystal layer and two sheets of light polarizing plates provided with the liquid crystal layer interposed therebetween.

### INDUSTRIAL APPLICABILITY

The invention can prevent crosstalk by a fluorescent substrate for preventing the generation of a phenomenon in which a phenomenon in which a display color becomes faint is prevented, so that a display device having high definition can be provided.

### REFERENCE SIGNS LIST

10 FLUORESCENT SUBSTRATE
11 SUBSTRATE
12 PIXEL
12R RED SUB-PIXEL
12B BLUE SUB-PIXEL
12G GREEN SUB-PIXEL
12YE YELLOW SUB-PIXEL
13 PARTITION
14 RED PHOSPHOR LAYER
15 BLUE PHOSPHOR LAYER
16 GREEN PHOSPHOR LAYER
17 RED COLOR FILTER
18 BLUE COLOR FILTER
19 GREEN COLOR FILTER
20 BLACK MATRIX
21 LOW REFRACTIVE INDEX LAYER
30,40,50,60,70 FLUORESCENT SUBSTRATE
71 YELLOW PHOSPHOR LAYER
72 COLOR FILTER
80,90 FLUORESCENT SUBSTRATE
100 DISPLAY DEVICE
110 LIGHT SOURCE
120 EXITATION LIGHT AMOUNT MODULATION LAYER
121,122 LIGHT POLARIZING PLATE
123 LIQUID CRYSTAL LAYER
124 LIGHT SHIELDING LAYER (BLACK MATRIX)
131 SEALING SUBSTRATE
190 CELLULAR PHONE
191 SOUND INPUT PORTION
192 SOUND OUTPUT PORTION
193 ANTENNA
194 OPERATING SWITCH
195 DISPLAY PORTION
196 HOUSING
200 THIN-TYPE TELEVISION
201 DISPLAY PORTION
202 SPEAKER
203 CABINET
204 STAND
210 PORTABLE GAME MACHINE
211,212 OPERATOR BUTTON
213 EXTERNAL CONNECTING TERMINAL
214 DISPLAY PORTION
215 HOUSING
220 NOTEBOOK COMPUTER
221 DISPLAY PORTION
222 KEYBOARD
223 TOUCHPAD
224 MAIN SWITCH
225 CAMERA
226 RECORDING MEDIUM SLOT
227 HOUSING
230 TABLET TERMINAL
231 DISPLAY PORTION (TOUCHPANEL)
232 CAMERA
233 HOUSING

1. A fluorescent substrate comprising:
a substrate;
pixels provided on the substrate; and
partitions that partition the pixels,
wherein each of the pixels includes at least
a red sub-pixel that performs display of red light;
a blue sub-pixel that performs display of blue light; and
a third color sub-pixel that performs display of third color light different from the two colors, and
wherein a distance between the red sub-pixel and the blue sub-pixel is greater than a distance between other sub-pixels.

2. The fluorescent substrate according to claim 1,
wherein a red phosphor layer that emits red light from excitation light incident from an excitation light source is provided in the red sub-pixel, a blue phosphor layer that emits blue light from the excitation light is provided in the blue sub-pixel, and a third color phosphor layer that emits third color light from the excitation light is provided in the third color sub-pixel.

3. The fluorescent substrate according to claim 1,
wherein a red phosphor layer that emits red light from excitation light incident from an excitation light source is provided in the red sub-pixel, a light scattering layer that scatters the excitation light is provided in the blue sub-pixel, and a third color phosphor layer that emits third color light from the excitation light is provided in the third color sub-pixel.

4. The fluorescent substrate according to any one of claim 1,
wherein the third color is green.

5. The fluorescent substrate according to claim 4,
wherein the pixel further includes a fourth color sub-pixel that performs display of fourth color light which is the same as or different from the red light, the blue light, or the green light, and
wherein the red sub-pixel and the blue sub-pixel are provided so that respective long sides are separate from each other.

6. The fluorescent substrate according to claim 5,
wherein a fourth color phosphor layer that emits a fourth color from the excitation light is provided in the fourth color sub-pixel.

7. The fluorescent substrate according to claim 5,
wherein, when a main wavelength of the red light displayed by the red sub-pixel is λᵣ, a main wavelength of the blue light displayed by the blue sub-pixel is λ_{b}, and a main wavelength of the fourth color light displayed by the fourth color sub-pixel is λ₄, a relationship of λ_{b}<λ₄<λᵣ is satisfied.

8. The fluorescent substrate according to claim 5,
wherein, when a main wavelength of the red light displayed by the red sub-pixel is λᵣ, a main wavelength of the green light displayed by the green sub-pixel is λ_{g}, and a main wavelength of the fourth color light displayed by the fourth color sub-pixel is λ₄, a relationship of λ_{g}<λ₄<λᵣ is satisfied.

9. The fluorescent substrate according to claim 5,
wherein when a main wavelength of the green light displayed by the green sub-pixel is λ_{g}, and a main wavelength of the fourth color light displayed by the fourth color sub-pixel is λ₄, a relationship of λ₄=λ_{g} is satisfied.

10. A display device comprising:
fluorescent substrate according to any one of claim 1;
a light source having directivity that emits excitation light radiated on the pixel; and
an excitation light amount modulation layer that overlaps the fluorescent substrate and adjusts a light amount of the excitation light incident on the pixel of the fluorescent substrate.

11. The display device according to claim 10,
wherein a pixel opening portion of a phosphor in the fluorescent substrate and a pixel opening portion of the excitation light amount modulation layer are formed so that positions thereof substantially coincide.

12. The display device according to claim 10,
wherein the excitation light amount modulation layer is formed of a liquid crystal layer and two sheets of light polarizing plates provided with the liquid crystal layer interposed therebetween.
